(19) United States
(12) Patent Application Publication
(10) Pub. No.: US 2008/0227001 A1
(43) Pub. Date: Sep. 18, 2008

(54) IMAGE FORMING METHOD AND PROCESS CARTRIDGE

(76) Inventors: Takuya KADOTA, Kobe-shi (JP); Chiyoshi Nozaki, Otsu-shi (JP); Tsuyoshi Nozaki, Osaka (JP); Hiroyuki Murakami, Osaka (JP); Mitsuyo Matsumoto, Osaka (JP); Atsushi Yamamoto, Kawanishi-shi (JP); Tetsumaru Fujita, Nishinomiya-shi (JP); Yuji Nagatomo, Osaka (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/048,689

(22) Filed: Mar. 14, 2008

(30) Foreign Application Priority Data
Mar. 15, 2007 (JP) 2007-067354

(51) Int. Cl. G03G 13/04; G03G 15/00

(52) U.S. Cl. 430/48; 399/159

(57) ABSTRACT

An image forming method, including recharging untransferred toner remaining on a latent electrostatic image bearing member by using a recharging member to remove the untransferred toner from the latent electrostatic image bearing member, wherein the recharging member is a conductive member a surface of which has a contact angle of 108° or more with pure water and a Shore D hardness of 50 to 65; the coverage of the surface of the toner by an external additive is 150% or less; and a releasing agent peak ratio obtained by ATR method is 0.02 to 0.1.

### BACKGROUND OF THE INVENTION

1. Field of the Invention

The present invention relates to an electrophotographic image forming method, an electrophotographic process cartridge, and an electrophotographic image formation apparatus. The present invention specifically relates to an image forming method used for copying machines, printers, and the like that apply electrophotographic techniques using a toner for developing electrostatic charge. The present invention particularly relates to an image forming method, a process cartridge, and an image formation apparatus that enables reusing a toner remaining on a latent electrostatic image bearing member without collecting and discarding the toner; preventing contamination of the latent electrostatic image bearing member recharging member; easy collecting of the remaining toner in a developing step; and excellent image stability.

2. Description of the Related Art

A conventionally and widely used method for collecting a toner remaining on a latent electrostatic image bearing member after toner transfer is a contact cleaning method where a cleaning member is used to bring an elastic body into contact with the latent electrostatic image bearing member. As for the remaining toner removed from the latent electrostatic image bearing member by the cleaning method, the cleaning method is combined with a method where the remaining toner is collected into a container as waste toner.

The method of collecting a toner remaining on a latent electrostatic image bearing member after toner transfer by using a cleaning member does not comply with environmental measures required in the field in view of generation of waste toner. The method also requires space for the collecting container and which requirement is not suitable for size reduction or saving space.

As one of techniques for dealing with the environmental issues, there is a cleaner-less image forming method where images are recorded without using a unit for cleaning untransferred toner. By using the cleaner-less image forming method, a toner remaining on a latent electrostatic image bearing member can be used again on image formation. The method is thus extremely useful for image formation apparatuses that can reduce environmental loads.

The cleaner-less image forming method does not need the collecting container and use of the method thus has an aspect of enabling apparatus size reduction. That is, use of the method can satisfy one of the needs, apparatus size reduction, for printers and copying machines using electrophotographic techniques. The cleaner-less image forming method is thus an extremely advantageous technique with which environmental loads can be addressed and size reduction of image formation apparatuses can be developed.

The cleaner-less image forming method, however, is known to have a drawback that untransferred toner is not fully removed from the image formation process, causing contamination of members or image defects by adhesion of the toner.

In order to overcome the problem, for example, Japanese Patent Application Laid-Open (JP-A) No. 11-184216 discloses an invention where for the purpose of preventing contamination of an image formation apparatus by toner components, a sheet is provided to physically separate the space, preventing untransferred toner from adhering to the members. Japanese Patent (JP-B) No. 3190217 discloses an invention where untransferred toner remaining on a latent electrostatic image bearing member is recharged to have normal charged polarity on the whole by using a blade, using the toner again for development and removing the toner from the image formation process.

In recent years, for the purpose of size reduction and cost reduction, there has been the widespread use of oilless fixing using a toner containing a releasing agent such as wax instead of using an oil applying unit in a fixing member. In using the toner containing a releasing agent, the releasing agent exposed on the surface of the toner induces adhesion of the toner to various members, spent, and the like, frequently causing adhering matter.

Thus not sufficiently controlling the properties of the sheet and the blade and adhesive components in a toner, the inventions disclosed in JP-A No. 11-184216 and JP-B No. 3190217 cannot completely prevent the toner from adhering to various members particularly in an image formation apparatus using a toner containing a releasing agent. The inventions thus have drawbacks of causing adhering matter, nonuniform charging, and image defects.

### BRIEF SUMMARY OF THE INVENTION

As mentioned above, generation of adhered toner is perceived as a problem in the cleaner-less image forming method. Then the present inventors have thoroughly examined the problem as mentioned below.

In the electrophotographic image formation process, after a developed toner is transferred from a latent electrostatic image bearing member, the charge of a toner remaining on the member is extremely reduced and the remaining toner carries no charge or oppositely charged.

The remaining toner is not removed from the surface of the latent electrostatic image bearing member in image formation apparatuses and process cartridges without having cleaning members. The remaining toner is then carried to the charging member portion for the latent electrostatic image bearing member in a charging step, and adhered to the contact type charging member portion for the latent electrostatic image bearing member. The adhered toner can cause nonuniform charging on charging the latent electrostatic image bearing member.

It is thus necessary to remove the adhered toner. A conceivable removing method is to produce potential difference between the charging member for the latent electrostatic image bearing member and the latent electrostatic image bearing member, making the toner adhere to the latent electrostatic image bearing member and collecting the toner in the developing step. In using this method, to move the toner in accordance with the potential difference, the toner on the whole is required to carry charge in the same polarity and contain only a small amount of toner with opposite polarity.

In collecting the toner in the developing step, the toner is required to carry charge equal to or higher than the pre-transfer toner and contain only a small amount of toner with opposite polarity. A conceivable collecting method in the developing step is to produce potential difference between a developing roller and the latent electrostatic image bearing member, making the toner adhere to the developing roller and collecting the toner. When there is large amount of toner with opposite polarity, the toner cannot be collected sufficiently by potential difference and remains on the surface of the latent electrostatic image bearing member. This causes scumming and contamination of members, and image stability over time cannot be achieved.

Then a method is conceived where a recharging member is provided for recharging toner remaining on the latent electrostatic image bearing member to prevent contamination of the charging member for the latent electrostatic image bearing member. The method, however, can cause contamination by toner components because the recharging member for recharging toner remaining on the latent electrostatic image bearing member rubs against the toner.

The present invention has been accomplished to overcome the problems. An object of the present invention is to provide an image forming method, a process cartridge, and an image formation apparatus that recharges toner remaining on a latent electrostatic image bearing member for reusing the toner without collecting and discarding the toner; prevents contamination of a charging member for the latent electrostatic image bearing member and a recharging member; facilitates collecting of the remaining toner in a developing step; and provides excellent image stability and less deterioration in durability.

The present inventors have thoroughly studied and have found that the problems are overcome by an image forming method, at least including: forming a latent electrostatic image on a latent electrostatic image bearing member for bearing the latent electrostatic image; developing the latent electrostatic image to form a visible toner image by using a toner; and recharging untransferred toner remaining on the latent electrostatic image bearing member by using a recharging member to remove the remaining toner from the latent electrostatic image bearing member; wherein the recharging member is a conductive member a surface of which has a contact angle of 108° or more with pure water and a Shore D hardness of 50 to 65; and the toner is formed by making an external additive adhering to a toner base granulated by dispersing and/or emulsifying in an aqueous medium an oil phase containing a toner composition that contains at least a pigment, a releasing agent, and a modified laminar inorganic mineral obtained by modifying at least part of interlayer ions by using organic ions and/or a precursor of the toner composition, the coverage of the surface of the toner by the external additive is 150% or less, which coverage is calculated from the average particle size of the toner base and the external additive; and a ratio between a peak of 2,850 cm⁻¹ from the releasing agent and a peak of 828 cm⁻¹ from a binder resin is 0.02 to 0.1, which peaks are obtained by ATR method. The present invention thus has been accomplished.

That is, to overcome the problems, the image forming method, the process cartridge, and the image formation apparatus according to the present invention specifically have technical features described in the following (1) to (25).

(1) An image forming method including forming a latent electrostatic image on a latent electrostatic image bearing member; developing the latent electrostatic image to form a visible toner image by using a toner; and recharging untransferred toner remaining on the latent electrostatic image bearing member by using a recharging member to remove the remaining toner from the latent electrostatic image bearing member; wherein the recharging member is a conductive member a surface of which has a contact angle of 108° or more with pure water and a Shore D hardness of 50 to 65; and the toner is formed by making an external additive adhering to a toner base granulated by dispersing and/or emulsifying in an aqueous medium an oil phase containing a toner composition that contains at least a pigment, a releasing agent, and a modified laminar inorganic mineral obtained by modifying at least part of interlayer ions by using organic ions and/or a precursor of the toner composition, the coverage of the surface of the toner by the external additive is 150% or less, which coverage is calculated from the average particle size of the toner base and the external additive; and a ratio between a peak of 2,850 cm⁻¹ from the releasing agent and a peak of 828 cm⁻¹ from a binder resin is 0.02 to 0.1, which peaks are obtained by ATR method.
(2) The image forming method according to the item (1), wherein the conductive member has a surface resistivity of 10² Ω/sq to 10⁸ Ω/sq.
(3) The image forming method according to the item (1), wherein the conductive member has a volume resistivity of 102Ω·cm to 106Ω·cm.
(4) The image forming method according to the item (1), wherein the conductive member is a conductive sheet that is pressed in contact with the surface of the latent electrostatic image bearing member.
(5) The image forming method according to the item (4), wherein the conductive sheet is composed of any one selected from nylon, PTFE, PVDF, and urethane.
(6) The image forming method according to any one of the items (4) and (5), wherein the conductive sheet has a thickness of 0.05 mm to 0.5 mm.
(7) The image forming method according to any one of the items (4) to (6), wherein a voltage of −1.4 kV to 0 kV is applied to the conductive sheet.
(8) The image forming method according to any one of the items (4) to (7), wherein the conductive sheet is in contact with the latent electrostatic image bearing member with a nip width of 1 mm to 10 mm.
(9) The image forming method according to the item (1), wherein the modified laminar inorganic mineral is obtained by modifying at least part of interlayer cations contained in layered inorganic mineral by using organic cations.
(10) The image forming method according to the item (1), wherein 0.05 weight percent to 2 weight percent of the modified laminar inorganic mineral is contained based on the solid content of the toner in the oil phase.
(11) The image forming method according to the item (1), wherein the toner has an acid value of 0.5 KOH mg/g to 40.0 KOH mg/g.
(12) The image forming method according to any one of the items (1) to (11), wherein the releasing agent contains one or more selected from the group consisting of paraffins, synthetic esters, polyolefins, carnauba waxes, and rice waxes; and the toner contains 1 part by mass to 4 parts by mass of the releasing agent based on 100 parts by mass of the binder resin.
(13) A process cartridge having a latent electrostatic image bearing member configured to bear a latent electrostatic image; a developing unit configured to develop the latent electrostatic image to form a visible image by using a toner; and a recharging unit configured to recharge untransferred toner remaining on the latent electrostatic image bearing member; wherein the recharging member is a conductive member a surface of which has a contact angle of 108° or more with pure water and a Shore D hardness of 50 to 65; and the toner is formed by making an external additive adhering to a toner base granulated by dispersing and/or emulsifying in an aqueous medium an oil phase containing a toner composition that contains at least a pigment, a releasing agent, and a modified laminar inorganic mineral obtained by modifying at least part of interlayer ions by using organic ions and/or a precursor of the toner composition, the coverage of the surface of the toner by the external additive is 150% or less, which coverage is calculated from the average particle size of the toner base and the external additive; and a ratio between a peak of 2,850 cm⁻¹ from the releasing agent and a peak of 828 cm⁻¹ from a binder resin is 0.02 to 0.1, which peaks are obtained by ATR method.
(14) The process cartridge according to the item (13), wherein the conductive member has a surface resistivity of 10² Ω/sq to 10⁸ Ω/sq.
(16) The process cartridge according to the item (13), wherein the conductive member has a volume resistivity of 10² Ω·cm to 10⁶ Ω·cm.
(16) The process cartridge according to the item (13), wherein the conductive member is a conductive sheet that is pressed in contact with the surface of the latent electrostatic image bearing member.
(17) The process cartridge according to the item (16), wherein the conductive sheet is composed of any one selected from nylon, PTFE, PVDF, and urethane.
(18) The process cartridge according to any one of the items (16) and (17), wherein the conductive sheet has a thickness of 0.05 mm to 0.5 mm.
(19) The process cartridge according to any one of the items (16) to (18), wherein a voltage of −1.4 kV to 0 kV is applied to the conductive sheet.
(20) The process cartridge according to any one of the items (16) to (19), wherein the conductive sheet is in contact with the latent electrostatic image bearing member with a nip width of 1 mm to 10 mm.
(21) The process cartridge according to the item (13), wherein the modified laminar inorganic mineral is obtained by modifying at least part of interlayer cations contained in layered inorganic mineral by using organic cations.
(22) The process cartridge according to the item (13), wherein 0.05 weight percent to 2 weight percent of the modified laminar inorganic mineral is contained based on the solid content of the toner in the oil phase.
(23) The process cartridge according to the item (13), wherein the toner has an acid value of 0.5 KOH mg/g to 40.0 KOH mg/g.
(24) The process cartridge according to the items (13) to (23), wherein the releasing agent contains one or more selected from the group consisting of paraffins, synthetic esters, polyolefins, carnauba waxes, and rice waxes; and the toner contains 1 part by mass to 4 parts by mass of the releasing agent based on 100 parts by mass of the binder resin.
(25) An image forming apparatus having a latent electrostatic image bearing member; a developing unit configured to develop a latent electrostatic image on the latent electrostatic image bearing member to form a visible toner image by using a toner; and a recharging member configured to recharge untransferred toner remaining on the latent electrostatic image bearing member; wherein the recharging member is a conductive member a surface of which has a contact angle of 108° or more with pure water and a Shore D hardness of 50 to 65; and the toner is formed by making an external additive adhering to a toner base granulated by dispersing and/or emulsifying in an aqueous medium an oil phase containing a toner composition that contains at least a pigment, a releasing agent, and a modified laminar inorganic mineral obtained by modifying at least part of interlayer ions by using organic ions and/or a precursor of the toner composition, the coverage of the surface of the toner by the external additive is 150% or less, which coverage is calculated from the average particle size of the toner base and the external additive; and a ratio between a peak of 2,850 cm⁻¹ from the releasing agent and a peak of 828 cm⁻¹ from a binder resin is 0.02 to 0.1, which peaks are obtained by ATR method.

The present invention can provide an image forming method, a process cartridge, and an image formation apparatus that reuses toner remaining on a latent electrostatic image bearing member without collecting and discarding the toner, thereby reducing environmental loads; prevents contamination of a charging member for the latent electrostatic image bearing member and a recharging member; facilitates collecting of the remaining toner in a developing step; and provides excellent image stability and less deterioration in durability.

### BRIEF DESCRIPTION OF THE SEVERAL VIEWS OF THE DRAWINGS

FIG. 1 is a schematic structural view of the main part of a printer to which a process cartridge according to the present invention is applicable; and

FIG. 2 is a schematic structural view of a process cartridge in an embodiment according to the present invention.

### DETAILED DESCRIPTION OF THE INVENTION

The present invention has features in a recharging unit configured to recharge toner that is not transferred and remains on a latent electrostatic image bearing member. The recharging unit is a conductive member a surface of which has a contact angle of 108° or more with pure water and a Shore D hardness of 50 to 65. The toner is formed by making an external additive adhering to a toner base granulated by dispersing and/or emulsifing in an aqueous medium an oil phase containing a toner composition that contains at least a pigment, a releasing agent, and a modified laminar inorganic mineral obtained by modifying at least part of interlayer ions by using organic ions and/or a precursor of the toner composition, the coverage of the surface of the toner by the external additive is 150% or less, which coverage is calculated from the average particle size of the toner base and the external additive; and a ratio between a peak of 2,850 cm⁻¹ from the releasing agent and a peak of 828 cm⁻¹ from a binder resin is 0.02 to 0.1, which peaks are obtained by ATR method.

The oil phase contains a pigment, a monomer and/or a prepolymer, a releasing agent, and a modified laminar inorganic mineral. The oil phase may further contain other suitable toner compositions such as a charge controlling agent. The oil phase preferably contains the toner compositions dispersed or dissolved in an organic solvent described later.

The solid content of toner in the present invention refers to what is ultimately contained in the toner such as the toner compositions contained in the oil phase. The toner composition precursor in the present invention refers to a precursor of a toner composition, which precursor forms one of toner compositions via polymerization or the like. The precursor specifically refers to a prepolymer, a monomer, or the like.

The present invention prevents generation of adhering matter around a latent electrostatic image bearing member, nonuniform charging and image defects caused by the adhering matter. The present invention is excellent in collecting a developer particularly in the cleaner-less system and can prevent generation of adhering matter.

The present invention prevents generation of adhering matter derived from a releasing agent component by selecting as a recharging member a member having low adhesion to the releasing agent component and high releasability, and by controlling the amount of the releasing agent exposed on the surface of toner. The surface uneven distribution effect of a modified laminar inorganic mineral probably further reduces the amount of the releasing agent exposed on the surface and provides toner releasability, thereby preventing generation of adhering matter, and achieving high image stability over time and excellent fixing property. Both the image stability and the fixing property are thus achieved at high levels.

Hereinafter, there is described, as a process cartridge according to the present invention and an image formation apparatus to which the process cartridge is applicable, an embodiment of an electrophotographic color laser printer (hereinafter, simply referred to as a printer) equipped with a process cartridge according to the present invention.

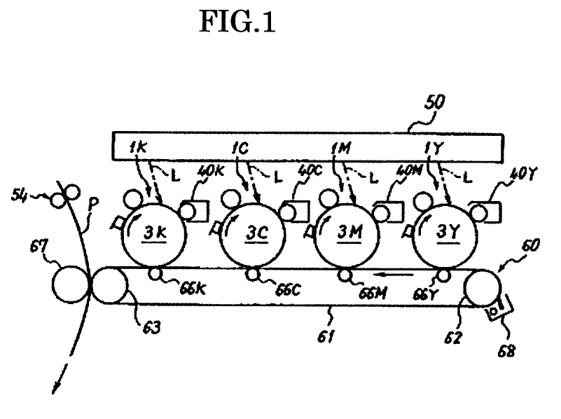

First, there is described the basic structure of a printer according to the present embodiment. FIG. 1 is a schematic structural view of the main part of the printer to which a process cartridge according to the present embodiment is applicable. To form a toner image of each color: yellow, magenta, cyan, and black (hereinafter, referred to as Y, M, C and K), the printer is equipped with four process cartridges 1Y, 1M, 1C and 1K. The printer is also equipped with an optical writing unit 50, a pair of resist rollers 54, a transfer unit 60, and the like. The character Y, M, C, or K after each numeral for a member means that the member is used for yellow, magenta, cyan, or black.

The optical writing unit 50, which is a unit for forming a latent image, includes components such as a light source composed of four laser diodes corresponding to each color of Y, M, C, and K; a polygon mirror having a regular hexahedron form; a polygon motor for rotating the mirror; a fθ lens; a lens; and a reflection mirror. A laser beam L emitted from a laser diode is reflected any one of the faces of the polygon mirror and deflected according to the rotation of the polygon mirror to reach any one of four photoconductors described later. Each of the surfaces of the four photoconductors are optically scanned with a laser beam L emitted from each of the four laser diodes.

The process cartridges 1Y, 1M, 1C and 1K includes components such as drum-shaped photoconductors 3Y, 3M, 3C, and 3K as latent image bearing members; developing devices 40Y, 40M, 40C and 40K as developing units corresponding to each of the 3Y, 3M, 3C, and 3K; and a charging unit. The photoconductors 3Y, 3M, 3C, and 3K are rotated clockwise in the figure at a predetermined linear velocity by a driving unit (not shown). Then the optical writing unit 50 emitting laser beams L modulated based on image data transmitted from a personal computer or the like (not shown) optically scans the photoconductors in the dark, whereby the photoconductors hold latent electrostatic images for Y, M, C, and K.

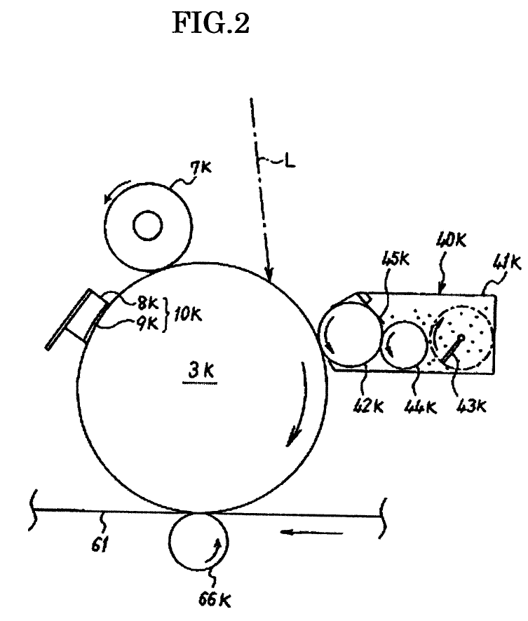

FIG. 2 is an enlarged structural view of the process cartridge 1K among the four process cartridges 1Y, 1M, 1C and 1K, and an intermediate transfer belt 61 of the transfer unit (60 in FIG. 1). The process cartridge 1K in FIG. 2 is detachably mounted as a single unit on the main unit of the printer by holding components such as the photoconductor 3K, the charging unit, a charge eliminating lamp (not shown), and a developing device 40K as a developing unit in a common unit casing (holding member).

The photoconductor 3K, which is a member to be charged and a member for holding a latent image, is a drum with a diameter of about 24 [mm] where the surface of a conductive base made of an aluminum tube is covered with a photosensitive layer made of negatively charged organic photoconductor (OPC). The photoconductor 3K is rotated clockwise in the figure at a predetermined linear velocity by a driving unit (not shown), whereby the surface of the photoconductor 3K passes a primary transfer nip (the contact point with the intermediate transfer belt 61), an auxiliary charging nip, a charging nip, an optical writing point, and a developing region in the order presented.

The developing device 40K for K has a developing roller 42K exposing part of its peripheral surface from the opening provided in a casing 41K. As for the developing roller 42K as a developer holding member, the shafts projected from the both longitudinal ends of the roller are rotatably supported by bearings (not shown). The casing 41K contains K toner, and the toner is conveyed from the right side to the left side in the figure by an agitator 43K being rotated. On the left side of the agitator 43K in the figure, a toner supplying roller 44K is provided, which is rotated counterclockwise in the figure by a driving unit (not shown). The roller portion of the toner supplying roller 44K is made of elastic foam such as sponge, and excellently traps the K toner carried from the agitator 43K. The trapped K toner is supplied to the developing roller 42K at the contact point between the toner supplying roller 44K and the developing roller 42K. Then the K toner held on the surface of the developing roller 42K as a developer holding member is subjected to the control of its layer thickness and the effect of frictional electrification on passing the contact point with a control blade 45K, and then the K toner is conveyed to the developing region facing with the photoconductor 3K according to the counterclockwise rotation in the figure of the developing roller 42K.

In the developing region, developing potential is effected between the developing roller 42K to which negative developing bias produced from a power supply (not shown) is applied and the latent electrostatic image on the photoconductor 3K so that negatively charged K toner is electrostatically moved from the developing roller 42K side to the latent image side. Non-developing potential is also effected between the developing roller 42K and the uniformly charged portion (base portion) on the photoconductor 3K so that negatively charged K toner is electrostatically moved from the base portion side to the developing roller 42K side. The K toner on the developing roller 42K is broken away from the developing roller 42K and transferred to the latent electrostatic image on the photoconductor 3K by the action of the developing potential. By the transfer, the latent electrostatic image on the photoconductor 3K is developed into a K toner image.

The printer mentioned herein uses a single component development method using a single component developer mainly containing the K toner as a developer for the developing device 40K. But, a two component development method may also be used that uses a two component developer containing the K toner and a magnetic carrier.

The K toner image developed in the developing region is conveyed according to the rotation of the photoconductor 3K to a primary transfer nip for K where the photoconductor 3K is in contact with the intermediate transfer belt 61, and intermediately transferred to the intermediate transfer belt 61. On the surface of the photoconductor 3K that has passed the primary transfer nip, there is untransferred toner, which has not been transferred to the intermediate transfer belt 61, adhering to the surface. The treatment of the untransferred toner is described later.

The charging unit is composed of components such as a charging brush roller 7K which is rotated counterclockwise in the figure and is in contact with the photoconductor 3K to form the charging nip; and an auxiliary charging member 10K which is in contact with the photoconductor 3K to form the auxiliary charging nip. The charging brush roller 7K is formed by covering the periphery of a metal rotating shaft member with a roller portion made of a conductive and elastic material such as conductive rubber. Charging bias is applied to the rotating shaft member by using a charging bias applying unit composed of a power supply (not shown). The application causes discharge between the charging brush roller 7K and the photoconductor 3K, whereby the surface of the photoconductor 3K is uniformly charged with the same polarity as the charged polarity of toner.

The auxiliary charging member 10K is formed by covering the surface of an elastic member 8K made of an elastic material such as sponge with a conductive sheet (a recharging member) 9K made of a conductive material. The auxiliary charging member 10K is pressed by a holder member toward the photoconductor 3K, whereby the sheet-covered surface of the member 10K is in contact with the portion of the periphery of the photoconductor 3K that has passed the primary transfer nip described later and is going to enter the charging nip. Auxiliary charging bias of direct voltage with the same polarity as the charging polarity of the toner or alternating voltage obtained by superimposing the direct voltages is fed to the conductive sheet 9K by using an auxiliary charging bias feed unit composed of a power supply (not shown).

The untransferred toner adhering to the surface of the photoconductor 3K that has passed the primary transfer nip includes a toner charged with normal charging polarity, low charged toner which is charged with normal charging polarity but the charging amount is not sufficient, and oppositely charged toner which is charged with opposite charging polarity. Such untransferred toner enters the auxiliary charging nip according to the rotation of the photoconductor 3K Then the oppositely charged toner in the untransferred toner is sufficiently charged with minus polarity, which is normal polarity, by discharge between the auxiliary charging member 10K and the photoconductor 3K or charge injection from the auxiliary charging member 10K. The low charged toner in the untransferred toner is also sufficiently charged with minus polarity by the discharge or the charge injection. As a result, scumming is prevented which is caused by conveying the oppositely charged toner or the low charged toner in the untransferred toner to the developing region.

### <Conductive Sheet (Recharging Member)>

The recharging member is desirably a sheet selected from nylon, PTFE, PVDF, and urethane sheets. PTFE and PVDF sheets are more preferable in view of toner charging properties.

The recharging member is preferably a conductive member a surface of which has contact angle of 108° or more with pure water and has a Shore D hardness of 50 to 65.

When the contact angle of the surface with pure water is less than 108°, the releasing property with a toner cannot be ensured, causing adherence of the toner to the conductive sheet. In addition, the shore D hardness is important because it affects change in properties with time such as durability. In the test of the present invention, it is found that it is advantageous in preventing the adherence of the toner to the conductive sheet to make a recharging member of a somewhat soft material contact with and rub against the surface of a photoconductor. This is conceivable because a contact state of the recharging member with the photoconductor varies due to deformation of material and vibration at the time of rubbing, and then the photoconductor also rubs against a toner remaining in a weak press-contact state on the photoconductor surface, thereby the toner peels off from the photoconductor surface. Further, it is also conceivable that the recharging member itself is peeled off due to rubbing friction of the material thereof. However, when the recharging member has an excessively high Shore D hardness, the adhesion of the recharging member to a photoconductor is increased and the toner does not pass therethrough. Thus, there is an appropriate hardness range. When the recharging member surface has a Shore D hardness less than 50, the adhesion between the photoconductor and the recharging member is increased, and the toner accumulates therebetween to cause toner adhesion to the sheet. When the recharging member surface has a Shore D hardness more than 65, it is impossible to prevent the toner from accumulating therebetween due to no occurrence of deformation and vibration of the material of the recharging member.

The conductive member preferably has a surface resistivity of 10² Ω/sq to 10⁸ Ω/sq. To uniformly discharge electricity through the photoconductor and the toner, the surface of the conductive member preferably has a medium-resistivity. When the surface resistivity is less than 10² Ω/sq, a leakage current occurs, and when more than 10⁸ Ω/sq, electric discharge does not occur.

The conductive member desirably has a volume resistivity of 10² Ω·cm to 10⁶ Ω·cm. When the volume resistivity is less than 10²Ω·cm, it provokes a leakage current, and when more than 10⁶ Ω·cm, it is difficult to generate uniform electric discharge through the photoconductor. To generate uniform discharge electricity through the photoconductor, the volume resistivity of the conductive member preferably has a resistivity that is slightly lower than the surface resistivity of the conductive member.

The conductive sheet desirably a sheet selected from nylon, PTFE, PVDF, and urethane sheets. PTFE and PVDF sheets are more preferable in view of toner charging properties.

Examples of the shape of the recharging member may include a roller, a brush, and a sheet. The shape is preferably a sheet structure in view of reset properties of toner adhered to the recharging member. The voltage applied to the recharging member is preferably −1.4 kV to 0 kV in view of charging toner.

When the voltage is more than −1.4 kV, the charged amount of the toner is excessively increased, and the adhesive force of the toner to the charging roller is excessively increased to cause contamination of the charging roller. When the voltage is set to higher than 0 kV, e.g, at a plus supply voltage, a sufficient amount of charge cannot be applied to the toner, still causing contamination of the charging roller.

When the recharging member is a conductive sheet, the sheet preferably has a thickness of 0.05 mm to 0.5 mm in view of the contact pressure between the member and the latent electrostatic image bearing member.

When the thickness of the sheet is less than 0.05 mm, the adhesion between the photoconductor and the recharging member is increased, and the toner accumulates therebetween to cause toner adhesion to the sheet. When the thickness of the conductive sheet is more than 0.5 mm, it is impossible to prevent the toner from accumulating therebetween due to no occurrence of deformation and vibration of the material of the recharging member.

The conductive sheet is in contact with the latent electrostatic image bearing member with a nip width of 1 mm to 10 mm. When the nip width is less than 1 mm, a charging defect of the toner and the photoconductor occurs, and when more than 10 mm, the downsizing of the image forming apparatus cannot be achieved.

The contact angle of a conductive sheet 9 with pure water can be determined by sessile drop method with a contact angle meter CA-DT.A type manufactured by Kyowa Interface Science Co., Ltd. according to the instruction manual of the contact angle meter. In the present embodiment, a conductive sheet 9 is used that has a contact angle of 108° or more with pure water.

As for the Shore D hardness of the conductive sheet 9, the Shore D hardness of the base is determined at 25° C. by a method according to ASTM D-2240. In the present embodiment, a conductive sheet 9 is used that has a Shore D hardness of 50 to 65. A conductive sheet 9K has a surface resistivity of 105 Ω/sq and a thickness of 0.1 mm.

The elastic portion 8K of the auxiliary charging member 10K is made of sponge and has a thickness of 5 mm. The auxiliary charging member 10K is pressed in contact with the photoconductor 3K at a contact pressure with which the thickness of the sponge is compressed to 2 [mm].

Further, by generating electric discharge between the conductive sheet 9K of the auxiliary charging member 10K and the photoconductor 3K, thereby secondarily charging the photoconductor 3K prior to the main charging process of the photoconductor 3K by using the charging brush roller 7K, nonuniform charging can be prevented.

On the surface of the photoconductor 3K uniformly charged at the charging nip, a latent electrostatic image for K is formed by optical scanning with the optical writing unit (50) described above. The latent electrostatic image is developed into a K toner image by using a developing device 40K for K.

### <Charging Brush Roller (Charging Member for Latent Electrostatic Image Bearing Member)>

In the present embodiment, a charging brush roller for each color such as 7K is a (φ) 10 [mm] roller where roller portion is formed by covering a 6 [mm] diameter metal rotating shaft member with a conductive rubber layer.

The process cartridge 1K for K has been described so far. The process cartridges 1Y, 1M and 1C for other colors have the same configurations as the process cartridge 1K for K and description for the cartridges is omitted.

As for the process cartridges 1Y, 1M, 1C and 1K according to the present embodiment, so-called cleaner-less system is used. The cleaner-less system is a system of conducting an image formation process on a latent image bearing member without using an extra unit for cleaning and collecting untransferred toner adhering to the latent image bearing member such as the photoconductor 3Y. The extra unit for cleaning and collecting specifically refers to a unit with which untransferred toner is separated from the latent image bearing member and the toner is then collected by conveying the toner to a waste toner container or the toner is collected for recycle by conveying the toner to a developing device without making the toner again adhering to the latent image bearing member. The extra unit includes a cleaning blade for scraping untransferred toner away from the latent image bearing member.

Such cleaner-less system is described in detail below. The cleaner-less system is broadly classified into scraping/passing type, temporarily trapping type, and combination type thereof. Among the types, the scraping/passing type reduces the adhesion between untransferred toner and a latent image bearing member by scraping the untransferred toner on the latent image bearing member by using a scraping member such as a brush rubbing against the latent image bearing member. After that, the untransferred toner on the latent image bearing member is collected into a developing device by electrostatically transferring the toner to a developing member such as a developing roller at immediately prior to a developing region or at the developing region where the developing member such as a developing sleeve or the developing roller and the latent image bearing member face to each other. Before the untransferred toner is collected, the toner passes the optical writing point for writing a latent image, but relatively small amount of the untransferred toner does not have adverse impact on writing a latent image. Note that the untransferred toner containing oppositely charged toner which is charged with polarity opposite to the normal polarity causes problems such as scumming because the oppositely charged toner is not collected to the developing member. For the purpose of preventing such generation of scumming caused by the oppositely charged toner, a toner charging unit for charging the untransferred toner on the latent image bearing member with the normal polarity is desirably provided at a position between transfer position such as primary transfer nip and scraping position by using the scraping member, or at a position between the scraping position and the developing region. The scraping member may include a stationary brush having a plurality of planted hair-like fibers that are conductive fibers bonded to a plate, a unit casing, or the like; a brush roller on which a plurality of hair-like fibers are planted upright on a metal rotating shaft member; and a roller member, such as a charging roller, having a roller portion made of conductive sponge or the like. The stationary brush is advantageous because the brush can be formed with a relatively small amount of planted hair-like fibers and inexpensive. But when the stationary brush is also used as a charging member for uniformly charging a latent image bearing member, sufficient charging uniformity cannot be obtained. In contrast, use of the brush roller is preferable to obtain sufficient charging uniformity.

In the temporarily trapping type of the cleaner-less system, untransferred toner on the latent image bearing member is temporarily trapped by using a trapping member such as a rotating brush member which is moved endlessly with keeping the surface of the brush to be in contact with the latent image bearing member. Then the untransferred toner is collected into a developing device by releasing the untransferred toner on the trapping member to transfer the toner again to the latent image bearing member, and electrostatically transferring the toner to a developing member such as a developing roller after completion of print job or at idle timing between print jobs (time space corresponding to an unprinted area between a previously printed transfer sheet and the next transfer sheet to be printed). When considerably large amount of untransferred toner is generated, for example, in forming a solid image or after jamming, use of the scraping/passing type can cause image degradation because the amount of the toner is beyond the collecting capacity of the developing member. In contrast, use of the temporarily trapping type can prevent such image degradation by gradually collecting untransferred toner trapped by a trapping member into the developing member.

The combination type in the cleaner-less system combines the scraping/passing type and the temporarily trapping type. Specifically, a rotating brush member or the like in contact with the latent image bearing member is used as both the scraping member and the trapping member. The rotating brush member or the like is used as the scraping member by applying only direct voltage to the brush member or the like while the rotating brush member or the like is used as the trapping member as required by changing the bias from the direct voltage to superimposed voltage.

The present printer employs the scraping/passing type cleaner-less system. Specifically, the photoconductor 3K is rotated clockwise in the figure at a predetermined linear velocity with being in contact with the front surface of the intermediate transfer belt 61 to form a primary transfer nip for Y. By making the auxiliary charging member 10K and the charging brush roller 7K as scraping members scrape untransferred toner on the photoconductor 3K, adhesion between the untransferred toner and the photoconductor 3K is reduced. After that, the untransferred toner on the photoconductor 3K is collected by electrostatically transferring the toner to the developing roller 42K in the developing device 40K. In this case, the untransferred toner containing large amount of low charged toner or oppositely charged toner can cause scumming or background smear because such toners are not collected onto the developing roller 42K. Also in the case, a large amount of a releasing agent exposed on the surface of the toner induces problems such as adhesion of the toner to the charging brush roller 7K (charging member for latent electrostatic image bearing member) or the auxiliary charging member 10K (recharging member), or spent, frequently causing generation of adhering matter.

In the FIG. 1 mentioned above, under the respective color process cartridges 1Y, 1M, 1C and 1K, a transfer unit 60 is provided. The transfer unit 60 carries an endless intermediate transfer belt 61 counterclockwise in the figure endlessly with spanning the belt 61 by using a plurality of spanning rollers. The plurality of spanning rollers specifically refer to a driven roller 62, a driving roller 63, four primary transfer bias rollers 66Y, 66M, 66C and 66K, and the like.

All of the driven roller 62, the primary transfer bias rollers 66Y to K, and the driving roller 63 are in contact with the back surface (loop inner surface) of the intermediate transfer belt 61. The four primary transfer bias rollers 66Y, 66M, 66C and 66K, are rollers where metal core bar is covered with an elastic body such as sponge. The rollers are pressed toward the photoconductors 3Y, 3M, 3C, and 3K for Y, M, C, and K respectively with interposing the intermediate transfer belt 61 between the rollers and the members. As a result, four primary transfer nips for Y, M, C, and K are formed where the four photoconductors 3Y, 3M, 3C, and 3K are in contact with the front surface of the intermediate transfer belt 61 over a predetermined length in the moving direction of the belt.

To each of the core bars of the four primary transfer bias rollers 66Y, 66M, 66C and 66K, primary transfer bias that is controlled to be constant current by transfer bias supply (not shown) is applied. As a result, transfer charge is imparted to the back surface of the intermediate transfer belt 61 via the four primary transfer bias rollers 66Y, 66M, 66C and 66K, forming transfer electric fields at the respective primary transfer nips between the intermediate transfer belt 61 and the photoconductors 3Y, 3M, 3C, and 3K Note that the present printer is equipped with the primary transfer bias rollers 66Y, 66M, 66C and 66K as primary transfer units, but a brush, a blade, or the like may be used instead of the rollers. A transfer charger may also be used.

Y, M, C and K toner images formed on the photoconductors 3Y, 3M, 3C, and 3K for respective colors are primarily transferred with superimposing the images onto the intermediate transfer belt 61 at the primary transfer nips for respective colors. As a result, a four-color-superimposed toner image (hereinafter, referred to as four-color toner image) is formed on the intermediate transfer belt 61.

At the position where the intermediate transfer belt 61 is spanned to the driving roller 63, a secondary transfer bias roller 67 is in contact with the front surface of the belt, forming a secondary transfer nip. To the secondary transfer bias roller 67, secondary transfer bias is applied by using a voltage applying unit composed of a power supply and wiring (not shown). As a result, a secondary transfer electric field is formed between the secondary transfer bias roller 67 and a grounded secondary transfer nip back side roller 64. The four-color toner image formed on the intermediate transfer belt 61 enters the secondary transfer nip according to endless moving of the belt.

The present printer is equipped with a paper cassette (not shown), which contains recording papers P as recording paper stack obtained by stacking a plurality of the papers. The topmost recording paper P is then supplied to a paper feeding path at a predetermined timing. The supplied recording paper P is caught in the resist nip of the pair of resist rollers 54 provided at the end of the paper feeding path.

Both of the rollers of the pair of resist rollers 54 are rotated to catch a recording paper P supplied from the paper cassette in the resist nip. But, the rotation of the rollers is stopped as soon as the pair catches the tip of the recording paper P between the rollers. The recording paper P is then supplied to the secondary transfer nip with a timing so that the paper is in synchronization with the four-color toner image on the intermediate transfer belt 61. At the secondary transfer nip, the four-color toner image on the intermediate transfer belt 61 is secondarily transferred collectively onto the recording paper P by the action of the secondary transfer electric field and nip pressure, providing a full-color image with the white of the recording paper P.

The recording paper P on which the full-color image is thus formed is ejected from the secondary transfer nip, and carried to a fixing device (not shown) to fix the full-color image.

Untransferred toner after the secondary transfer adhering to the surface of the intermediate transfer belt 61 that has passed the secondary transfer nip is removed from the belt surface by using a belt cleaning device 68.

Note that the printer in the embodiment uses minus charged Y, M, C, and K toners. The photoconductors 3Y, 3M, 3C, and 3K for respective colors are uniformly charged with minus polarity by using a charging device. After that, the minus potential of a latent electrostatic image formed by optical scanning is attenuated down to lower than that of the base portion. The printer employs a negative-positive developing method where toner with minus polarity is adhered to the latent electrostatic image with thus attenuated potential.

### <Toner>

Next, hereinafter, there is described in detail the toner used for the process cartridge according to the present invention.

### <Resin for Toner>

A resin for toner used in the present invention is not particularly limited, and can be properly selected according to a purpose. Particularly preferred resins may include styrene-acrylate resins and polyester resins.

In the present invention, polyester resins are preferably used. The types of the polyester resins are not particularly limited and any polyester resins may be used. Several types of polyester resins may also be used in combination. Examples of polyester resins may include condensation polymers of the following polyols (1) and polycarboxylic acids (2).

### (Polyols)

Examples of the polyols (1) may include: alkylene glycols such as ethylene glycol 1,2-propylene glycol 1,3-propylene glycol 1,4-butanediol, and 1,6-hexanediol; alkylene ether glycols such as diethylene glycol triethylene glycol dipropylene glycol polyethylene glycol polypropylene glycol and polytetramethylene ether glycol; alicyclic diols such as 1,4-cyclohexanedimethanol, and hydrogenated bisphenol A; bisphenols such as 4,4′-dihydroxybiphenyls (e.g., bisphenol A, bisphenol F, bisphenol S, and 3,3′-difluoro-4,4′-dihydroxybiphenyl); bis(hydroxyphenyl)alkanes (e.g., bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also known as tetrafluorobisphenol A), and 2,2-bis(3-hydroxyphenyl)-1,1,1,3,3,3-hexafluoropropane); and bis(4-hydroxyphenyl)ethers (e.g., bis(3-fluoro-4-hydroxyphenyl)ether); alkylene oxide (such as ethylene oxide, propylene oxide, and butylene oxide) adducts of the above alicyclic diols; and alkylene oxide (such as ethylene oxide, propylene oxide, and butylene oxide) adducts of the above bisphenols.

Preferred polyols among the above are C₂₋₁₂ alkylene glycols, and alkylene oxide adducts of bisphenols. Particularly preferred are alkylene oxide adducts of bisphenols and combination of alkylene oxide adducts of bisphenols and C₂₋₁₂ alkylene glycols.

Examples of the polyols (1) may further include: poly(3 to 8 or more)hydric aliphatic alcohols such as glycerin, trimethylolethane, trimethylolpropane, pentaerythritol and sorbitol; trihydric or more phenols such as trisphenol PA, phenol novolac, and cresol novolac; and alkylene oxide adducts of the trihydric or more phenols. Note that the polyols may be used alone or in combination, and not limited to the above examples.

### (Polycarboxylic Acid)

Examples of the polycarboxylic acids (2) may include: alkylene dicarboxylic acids such as succinic acid, adipic acid, and sebacic acid; alkenylene dicarboxylic acids such as maleic acid and fumaric acid; and aromatic dicarboxylic acids such as phthalic acid, isophthalic acid, terephthalic acid, naphthalene dicarboxylic acid, 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethylisophthalic acid, 2,2-bis(4-carboxyphenyl)hexafluoropropane, 2,2-bis(4-carboxyphenyl)hexafluoropropane, 2,2-bis(3-carboxyphenyl)hexafluoropropane, 2,2′-bis(trifluoromethyl)-4,4′-biphenyldicarboxylic acid, 3,3′-bis(trifluoromethyl)-4,4′-biphenyldicarboxylic acid, 2,2′-bis(trifluoromethyl)-3,3′-biphenyldicarboxylic acid, and hexafluoroisopropylidenediphthalic anhydride.

Preferred polycarboxylic acids among the above are C₄₋₂₀ alkenylene dicarboxylic acids and C₈₋₂₀ aromatic dicarboxylic acids. Examples of trihydric or more polycarboxylic acids may include C₉₋₂₀ aromatic polycarboxylic acids such as trimellitic acid and pyromellitic acid, or may be obtained by effecting reaction between anhydrides or lower alkyl esters such as methyl esters, ethyl esters, and isopropyl esters of the polycarboxylic acids and the polyols (1). Note that the polycarboxylic acids may be used alone or in combination, and not limited to the above examples.

### (Ratio Between Polyol and Polycarboxylic Acid)

The ratio between the polyol (1) and the polycarboxylic acid (2) is, relative to an equivalent ratio [OH]/[COOH] between a hydroxyl group [OH] and a carboxyl group [COOH], generally 2/1 to 1/1, preferably 1.5/1 to 1/1, and more preferably 1.3/1 to 1.02/1.

### (Molecular Weight of Polyester Resin)

The peak molecular weight of a polyester resin is generally 1,000 to 30,000, preferably 1,500 to 10,000, and more preferably 2,000 to 8,000. A polyester resin with a molecular weight of less than 1,000 has degraded thermal storage stability whereas a polyester resin with a molecular weight of more than 3,000 has degraded fixing properties in low temperatures.

### <Modified Polyester Resin>

The toner according to the present invention may include as a crosslinkable resin a modified polyester resin at least having a urea group for the purpose of adjusting viscoelasticity to prevent offset. Besides the urea group, the resin may also have a urethane bond. The content of the crosslinkable resin is preferably 30 mass percent or less in a binder resin, more preferably 3 mass percent to 30 mass percent, still more preferably 5 mass percent to 20 mass percent, and particularly preferably 7 mass percent to 20 mass percent. The content of more than 30 mass percent can result in degraded fixing properties in low temperatures. The content of less than 3 mass percent can result in degraded resistance to hot offset. The modified polyester resin having a urea group may be directly mixed with the binder resin. In view of productivity, however, it is preferred to prepare the modified polyester resin having a urea group by subjecting a relatively-low-molecular-weight modified polyester resin having an isocyanate group at its end (hereinafter, sometimes referred to as a prepolymer) and amines reactive to the prepolymer to chain elongation or/and crosslinking during or after granulation by O/W type wet granulation method. This preparation easily makes core portion contain a relatively-high-molecular-weight modified polyester resin for adjusting viscoelasticity.

### (Prepolymer)

The prepolymer having an isocyanate group may be obtained by effecting reaction between polyester and polyisocyanate (3), which polyester is a condensation polymer of the polyol (1) and the polycarboxylic acid (2), and the polyester has an active hydrogen group. Examples of the active hydrogen group of the above polyester may include hydroxyl groups (an alcoholic hydroxyl group and an phenolic hydroxyl group), an amino group, a carboxyl group, and a mercapto group. Among the examples, preferred is an alcoholic hydroxyl group.

### (Polyisocyanate)

Examples of the polyisocyanate (3) may include: aliphatic polyisocyanates such as tetramethylene diisocyanate, hexamethylene diisocyanate, and 2,6-diisocyanate methyl caproate; alicyclic polyisocyanates such as isophorone diisocyanate, and cyclohexylmethane diisocyanate; aromatic diisocyanates such as tolylene diisocyanate, and diphenylmethane diisocyanate; aromatic aliphatic diisocyanates such as α,α,α′,α′-tetramethylxylylene diisocyanate; isocyanurates; the above polyisocyanates blocked with a phenol derivative, oxime, and caprolactam; and combination of the foregoing.

### (Ratio of Isocyanate Group and Hydroxyl Group)

The equivalent ratio between isocyanate groups [NCO] of the polyisocyanate (3) to hydroxyl groups [OH] of polyester with a hydroxyl group, [NCO]/[OH], is generally 5/1 to 1/1, preferably 4/1 to 1.2/1, and more preferably 2.5/1 to 1.5/1. [NCO]/[OH] of more than 5 results in degraded fixing properties in low temperatures. When the molar ratio of [NCO] is less than 1, modified polyester contains only a small amount of urea, resulting in degraded resistance to offset. The content of the polyisocyanate (3) component in a prepolymer (A) having an isocyanate group at its end is generally 0.5 weight percent to 40 weight percent, preferably 1 weight percent to 30 weight percent, and more preferably 2 weight percent to 20 weight percent. The content of less than 0.5 weight percent results in degraded resistance to offset. The content of more than 40 weight percent results in degraded fixing properties in low temperatures.

### (The Number of Isocyanate Groups in Prepolymer)

The number of the isocyanate groups of the prepolymer (A) having an isocyanate group per molecule is generally 1 or more, preferably 1.5 to 3 on average, and more preferably 1.8 to 2.5 on average. When the number of the isocyanate groups is less than 1 per molecule, modified polyester after chain elongation and/or crosslinking has low molecular weight, resulting in degraded resistance to offset.

(Chain Elongation and/or Crosslinking Agent)

In the present invention, amines may be used as a chain elongation and/or a crosslinking agent. Examples of the amines (B) may include: diamine (B1), trivalent or more polyamine (B2), amino alcohol (B3), amino mercaptan (B4), amino acids (B5), and compounds (B6) obtained by blocking the amino groups of B1 to B5.

Examples of the diamine (B1) may include: aromatic diamines such as phenylenediamine, diethyltoluenediamine, 4,4′diaminodiphenylmethane, tetrafluoro-p-xylylenediamine, and tetrafluoro-p-phenylenediamine; alicyclic diamines such as 4,4′-diamino-3,3′-dimethyldicyclohexylmethane, diaminecyclohexane, and isophoronediamine; and aliphatic diamines such as ethylenediamine, tetramethylenediamine, hexamethylenediamimine, dodecafluorohexylenediamine, and tetracosafluorododecylenedmine. Examples of the trivalent or more polyamine (B2) may include diethylenetriamine, and triethylenetetramine. Examples of the amino alcohol (B3) may include ethanolamine, and hydroxyethylaniline. Examples of the amino mercaptan (B4) may include aminoethyl mercaptan, and aminopropyl mercaptan. Examples of the amino acids (B5) may include aminopropionic acid, and aminocaproic acid. Examples of the compounds (B6) obtained by blocking the amino groups of B1 to B5 may include: ketimine compounds and oxazoline compounds obtained from the amines of B1 to B5 and ketones such as acetone, methyl ethyl ketone, and methyl isobutyl ketone.

### (Terminator)

A terminator may be used if necessary in chain elongation and/or crosslinking reaction, whereby the molecular weight of modified polyester after the reaction is complete can be adjusted. Examples of the terminator may include: monoamines such as diethylamine, dibutyl amine, butyl amine, and lauryl amine, and blocked compounds of the foregoing such as ketimine compounds.

### (Ratio of Amino Group and Isocyanate Group)

The ratio of the amines (B) is, relative to an equivalent ratio [NCO]/[NHx] between the isocyanate group [NCO] of the prepolymer (A) having the isocyanate group and the amino group [NHx] of the amines (B), generally 1/2 to 2/1, preferably 1.5/1 to 1/1.5, and more preferably 1.2/1 to 1/1.2. When the [NCO]/[NHx] is more than 2 or less than 1/2, urea modified polyester (i) has low molecular weight, resulting in degraded resistance to hot offset.

### <Colorant>

As for a colorant for the present invention, any known dyes and pigments may be used. Examples of the colorant may include: carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and mixtures of the foregoing. The content of the colorant is generally 1 weight percent to 15 weight percent based on the toner, preferably 3 weight percent to 10 weight percent.

### <Masterbatching of Colorant>

A colorant used in the present invention may also be used as a masterbatch obtained by combining the colorant and a resin. Examples of a binder resin which is used for producing the masterbatch or kneaded with the masterbatch may include: the modified and unmodified polyester resins mentioned above; polymers of styrene and substituted styrene such as polystyrene, poly-(p-chlorostyrene), and polyvinyltoluene; styrene-based copolymers such as styrene-p-chlorostyrene copolymer, styrene-propylene copolymer, styrene-vinyltoluene copolymer, styrene-vinylnaphthalin copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleate copolymer; polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic resin, rosin, modified rosin, terpene resin, aliphatic or alicyclic hydrocarbon resin, aromatic petroleum resin, chlorinated paraffin, and paraffin wax. The binder resins may be used alone or in combination.

### <Method for Preparing Masterbatch>

The masterbatch may be obtained by mixing and kneading a resin and a colorant for masterbatch under the application of high shear force. At this time, an organic solvent may be used to enhance the interaction between the colorant and the resin. A so-called flashing method, where aqueous paste containing colorant water is mixed and kneaded with a resin and an organic solvent to transfer the colorant to the resin, and water content and organic solvent component are removed, may also be preferably used because wet cake of the colorant may be directly used without drying the cake. For the mixing and kneading, preferably used is a high-shearing dispersion apparatus such as a triple roll mill.

### <Modified Laminar Inorganic Mineral>

In the present invention, modified laminar inorganic mineral that is obtained by substituting at least part of metallic ions of layered inorganic mineral with organic ions is used. Inorganic filler may be used as additional filler as long as use of the filler does not hamper the objects of the present invention. The additional filler is selected from the group of metal oxide, metal hydroxide, metal carbonate, metal sulfate, metal silicate, metal nitride, metal phosphate, metal borate, metal titanate, metal sulfide, and carbons.

In the case of using filler at least mainly containing an inorganic compound for toner prepared by aqueous granulation method, the filler tends to be present at the surfaces of toner particles. In the case of using filler and wax at least mainly containing an inorganic compound for toner prepared by aqueous granulation method, it is conventionally difficult to control the amount of the wax or the filler present in the vicinity of toner surface. Large amount of the wax present in the vicinity of toner surface results in enhanced fixing properties but contamination of other members by the wax. Large amount of the filler present in the vicinity of toner surface reduces contamination of other members caused by the wax and enhances charging properties while exudation of the wax and a binder resin is inhibited, impairing fixing properties, particularly fixing properties in low temperatures.

In the present invention, use of wax for toner prepared by aqueous granulation method enables control of the amount of the wax present in the vicinity of toner surface and prevention of contamination of other members by the wax.

As a method of determining the amount of wax present in the vicinity of toner surface, FTIR-ATR (total reflection-absorption infrared spectroscopy) can be employed. The amount of wax that is present from the surface to a depth of 0.3 μm of the toner surface can be measured and an intensity ratio represented by (P2850/P828) between 2,850 cm⁻¹ and 828 cm⁻¹ is determined by the ATR method. When the intensity ratio is 0.02 to 0.1, the wax can be prevented from contaminating other members. This mechanism is not clearly known, but the absorption at 2,850 cm⁻¹ probably includes the absorption of the wax, and the absorption at 828 cm⁻¹ probably includes the absorption of an aromatic compound used for a polyester resin as a binder resin. As a result, when the intensity ratio (P2,850/P828) is 0.02 to 0.1, the amount of exposed wax on toner surface is probably some constant value. It is thus expected that the ratio of less than 0.02 results in degradation of fixing properties because of decreased amount of exposed wax on toner surface, and the ratio of more than 0.1 results in contamination of other members because of increased amount of exposed wax on toner surface. In toner obtained at least through a step of emulsifying or dispersing a toner material solution in an aqueous medium, the layered inorganic mineral probably controls the amount of exposed wax on toner surface. This mechanism is not clearly known, but the layered inorganic mineral is modified to be hydrophobic by using organic ions though the original mineral has good wettability to water. The mineral is thus hydrophobic but still a little hydrophilic. Because of the hydrophilicity, the layered inorganic mineral is dispersed unevenly on toner surface, and which uneven dispersion is thought to decrease the amount of exposed wax on toner surface.

In the present invention, by using, as a filler, layered inorganic mineral obtained by modifying at least part of metal ions by using organic ions for toner granulated by dispersing in an aqueous medium, the shape of the toner is easily deformed. The layered inorganic mineral is highly hydrophilic because of its layer structure. The modified laminar inorganic mineral, used for toner according to the present invention, obtained by modifying at least part metal cations contained in layered inorganic mineral by using organic cations is preferably mineral having smectite-based basic crystal structure modified by using organic cations. Examples of the layered inorganic mineral modified by using organic cations may include: montmorillonite, bentonite, beidellite, nontronite, saponite, and hectorite.

As for an organic ion modifying agent for the modified laminar inorganic mineral obtained by modifying at least part metal ions contained in layered inorganic mineral by using organic ions, an organic cation modifying agent is desirable. Examples of the organic cation modifying agent may include quaternary alkyl ammonium salts, phosphonium salts, and imidazolium salts; preferably quaternary alkyl ammonium salts. Examples of the quaternary alkyl ammonium salts may include: trimethylstearylammonium, dimethylstearylbenzylammonium, dimethyloctadecylammonium, and oleylbis(2-hydroxyethyl)methylammonium.

By modifying at least part of layered inorganic mineral by using organic ions, the mineral has moderate hydrophobicity, oil phase containing a toner composition and/or a precursor of a toner composition has non-Newtonian viscosity, and toner can be deformed. In this case, the content of the layered inorganic mineral partly modified by using organic ions in toner materials is preferably 0.05 weight percent to 2 weight percent. The layered inorganic mineral partly modified by using organic cations is properly selected, and examples of the mineral may include one or a mixture of two or more selected from montmorillonite, bentonite, hectorite, attapulgite, and sepiolite. Among the examples, organically modified montmorillonite or bentonite is preferable because such minerals do not impact on toner properties, the viscosities of such minerals can be easily adjusted, and such minerals can be added in a small amount.

Examples of commercially available layered inorganic mineral partly modified by using organic ions may include: quaternium 18 bentonites such as Bentone 3, Bentone 38, Bentone 38V (Bentones are manufactured by Rheox), Tixogel VP (manufactured by United catalyst Inc.), Claytone 34, Claytone 40, and Claytone XL (Claytones are manufactured by Southern Clay Products, Inc.); stearalkonium bentonites such as Bentone 27 (manufactured by Rheox), Tixogel LG (manufactured by United catalyst Inc.), Claytone AF, and Claytone APA (Claytones are manufactured by Southern Clay Products, Inc.); and quaternium 18/benzalkonium bentonites such as Claytone HT, and Claytone PS (Claytones are manufactured by Southern Clay Products, Inc.). Particularly preferred minerals are Claytone AF, and Claytone APA.

In the present invention, organically modified hydrotalcite (organic anion modified hydrotalcite) may also be preferably used. The hydrotalcite is, for example, an organically modified hydrotalcite where layered double hydroxide salt contains monovalent and/or divalent and trivalent metal cations, and the hydrotalcite is modified by using one or more organic anions represented by a formula (I),

X—R—Y (1)

wherein X represents hydroxylcarboxyl, sulfate, or sulfo; Y represents carboxyl, sulfate, or sulfo; and R represents at least a C₈ in total for example, C₈₋₅₀, particularly C₁₀₋₄₄, more preferably C₁₀₋₃₂, aliphatic, alicyclic, heterocyclic aliphatic, olefin, cycloolefin, heterocyclic olefin, aromatic, heterocyclic aromatic, aromatic aliphatic, or heterocyclic aromatic aliphatic group optionally containing one or more types, preferably one, two, three, or four types of substituents selected from the group of hydroxylamino, halogen, C₁₋₂₂-alkyl C₁₋₂₂-alkoxy, —C₁₋₂₂-alkylene-(CO)—O—(CH₂CH₂O)₀₋₅₀-alkyl, —C₁₋₂₂-alkylene-(CO)—O—(CH₂CH₂O)₀₋₅haloalkyl, carboxy, sulfo, nitro, and cyano. Organically modified hydrotalcite that is modified by using organic anions disclosed in Japanese Patent Application Laid-Open (JP-A) No. 2006-503313 may also be used.

The double hydroxide salt contains hydroxyl groups about 1.8 times to 2.2 times, preferably about 2 times in number more than the total number of all the metal cations. The molar ratio of the monovalent and/or the divalent metal cation to the trivalent metal cation may be 10⁴ to 10⁻⁴, preferably 10 to 0.1, and particularly 5 to 0.2.

The ratio of the monovalent metal cation to the divalent metal cation may be any value. However, the double hydroxide salt preferably contains the trivalent metal cation and only the divalent metal cation or a mixture of the monovalent metal cation and the divalent metal cation.

The organic anion may be a monovalent or polyvalent charged organic anion represented by the formula (I). The amount of the anion is stoichiometrically determined so that sum of the all charges of positive charges and negative charges in the double hydroxide salt is zero. However, part of the anion represented by the formula (I), for example, 0.1 mole % to 99 mole %, particularly 1 mole % to 90 mole % of the anion may be substituted with other anions, for example, inorganic anion such as halide, hydrogencarbonate, carbonate, sulfate, nitrate, phosphate, borate, or acetate.

The organically modified laminar inorganic mineral used in the present invention may be double hydroxide salt containing crystallized or intercalated-water-form water molecules in each interlayer.

Suitable monovalent metal cations are particularly alkali metal cations such as Li⁺, Na⁺, or K⁺.

Suitable divalent metal cations are particularly cations such as Mg²⁺, Ca²⁺, Zn²⁺, Co²⁺, Ni²⁺, Fe²⁺, Cu²⁺, or Mn²⁺.

Suitable trivalent metal cations are particularly cations such as Al³⁺, Fe³⁺, Co³⁺, Mn³⁺, Ni³⁺, Cr³⁺, and B³⁺.

Particularly preferred double hydroxide salt contains Mg²⁺ and Al³⁺ particularly in a molar ratio of 3.1:1 to 1:2.

Suitable organic anions are anions preferably from the group of benzilic acid, naphthalenedisulfonic acid such as naphthalene-1,5-disulfonic acid, and naphthalenedicarboxylic acid; hydroxynaphthoic acid such as 1-hydroxy-2-naphthoic acid, 2-hydroxy-1-naphthoic acid, and 3-hydroxy-2-naphthoic acid; octanedicarboxylic acid, decanedicarboxylic acid (sebacic acid), dodecanedicarboxylic acid, tetradecanedicarboxylic acid, hexadecanedicarboxylic acid, octadecanedicarboxylic acid, naphthalenetetracarboxylic acid, sulfosuccinic acid (C₆ to C₂₂)-alkylmonoester, and sulfosuccinic acid (C₆ to C₂₂)-fluoroalkylmonoester.

Furthermore, part of; for example, 0.1 mole % to 99.9 mole %, preferably 0.2 mole % to 99.8 mole % of organic anion A may be substituted with other organic anions. The other organic anions are represented by a formula H—R—Y where R and Y have the same definitions as with the formula (I), and for example, C₁₂ to C₄₄ aliphatic acid, particularly stearic acid.

Particularly preferred double hydroxide salt has a Mg:Al molar ratio of 3.1:1 to 1:2; the salt is associated with sebacic acid as an organic anion in each case; and the salt is in sintered form.

### <Releasing Agent>

The releasing agent used in the present invention preferably contains one or more selected from the group consisting of paraffins, synthetic esters, polyolefins, carnauba waxes, and rice waxes, and may further contain other known releasing agents.

Examples of the releasing agent may include: polyolefin wax such as polyethylene wax and polypropylene wax; long chain hydrocarbon such as paraffin wax and sazole wax; and carbonyl-group-containing wax. Examples of the carbonyl-group-containing wax may include: polyalkane acid ester such as carnauba wax, montan wax, trimethylolpropane tribehenate, pentaerythritol tetrabehenate, pentaerythritol diacetatedibehenate, glycerin tribehenate, and 1,18-octadecanediol distearate; polyalkanol ester such as tristearyl trimellitate, and distearyl maleate; polyalkane acid amide such as ethylenediamine dibehenylamide; polyalkyl amide such as trimellitic acid tristearylamide; and dialkyl ketone such as distearyl ketone. Among the carbonyl-group-containing waxes, preferred is polyalkane acid ester.

In the present invention, the toner preferably contains 1 part by mass to 4 parts by mass of the wax based on 100 parts by mass of a resin component. When the content of the wax is less than one part by mass based on the total amounts of the toner, releasing effect by the wax is not obtained, possibly resulting in no margin of preventing offset. In contrast, when the content of the wax is more than four parts by mass, the wax is melted in low temperatures and susceptible to thermal energy and mechanical energy. The wax thus comes out of toner on stirring the toner at developing region, and the wax can adhere to a toner controlling member or a latent electrostatic image bearing member, causing image noise. When the endothermic peak of the wax on heating the wax determined by using a differential scanning calorimetry (DSC) is 65° C. to 115° C., toner can be fixed in low temperatures. There is a tendency that melting point less than 65° C. results in poor flowability, and melting point more than 115° C. results in poor fixing properties.

### <Charge Controlling Agent>

The toner according to the present invention may further contain a charge controlling agent, if necessary. Any known charge controlling agent may be used. Examples of the charge controlling agent may include: nigrosine dyes, triphenylmethane dyes, chromium-containing metal complex dyes, molybdic acid chelate pigments, rhodamine dyes, alkoxy amines, quaternary ammonium salts including fluorine-modified quaternary ammonium salts, alkylamides, elemental phosphorus, phosphorus compounds, elemental tungsten, tungsten compounds, fluorine-based activators, metal salts of salicylic acid, and metal salts of salicylic acid derivatives. Specifically, examples of the charge controlling agent may include: BONTRON 03 (nigrosine dye), BONTRON P-51 (quaternary ammonium salt), BONTRON S-34 (metal-containing azo dye), E-82 (oxynaphthoic acid metal complex), E-84 (salicylic acid metal complex), and E-89 (phenolic condensation product), which are manufactured by Orient Chemical Industries, Ltd.; TP-302 and TP415 (quaternary ammonium salt molybdenum complex), which are manufactured by Hodogaya Chemical Co., LTD.; COPY CHARGE PSY VP2038 (quaternary ammonium salt), COPY BLUE PR (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, or a quaternary ammonium salt group.

### <External Additive>

### (Inorganic Particle)

Inorganic particles may be preferably used as an external additive for enhancing the flowability, developing properties, and charging properties of colored particles obtained in the present invention. The inorganic particles preferably have a primary particle size of 5 nm to 2 μm, in particular, 5 nm to 500 nm. The inorganic particles preferably have a specific surface of 20 m²/g to 500 m²/g determined by BET method. The ratio of the inorganic particles used is preferably 0.01 weight percent to 5 weight percent of the toner, in particular, 0.01 weight percent to 2.0 weight percent. Examples of the inorganic particles may include: silica, alumina, titanium oxide, barium titanate, magnesium titanate, calcium titanate, strontium titanate, zinc oxide, tin oxide, silica sand, clay, mica, wollastonite, diatom earth, chromium oxide, cerium oxide, colcothar, antimony trioxide, magnesium oxide, oxide complex such as silicon oxide/magnesium oxide or silicon oxide/aluminum oxide, zirconium oxide, barium sulfate, barium carbonate, calcium carbonate, silicon carbide, and silicon nitride.

### (Polymeric Particle)

Examples of the external additive may further include polymeric particles such as polystyrene obtained by soap free emulsion polymerization, suspension polymerization, or dispersion polymerization, methacrylate copolymer, acrylate copolymer, condensation polymers such as silicone, benzoguanamine, and nylon, and polymeric particles made of a thermosetting resin.

### (Surface Treatment for External Additive)

By subjecting such fluidizer to surface treatment to enhance its hydrophobicity, it is possible to prevent flowability and charging properties from degrading under high humidity. Examples of preferred surface treatment agent may include: silane coupling agents, silylation agents, silane coupling agents having a fluorinated alkyl group, organic titanate coupling agents, aluminum coupling agents, silicone oils, and modified silicone oils.

### (Cleaning Assistant)

Examples of a cleaning improver for removing a developer remaining on a latent electrostatic image bearing member or a primary transfer medium after transfer may include: metal salt of fatty acid such as zinc stearate, calcium stearate, and stearic acid, and polymer particles such as polymethylmethacrylate particles, and polystyrene particles prepared by soap free emulsion polymerization. The polymer particles preferably have relatively narrow particle size distribution and volume average particle size of 0.01 μm to 1 μm.

### <Method of Producing Toner>

When a toner material is emulsified or dispersed in an aqueous medium by using a solution containing the toner material, the solution containing the toner material is dispersed in an aqueous medium with stirring. For the dispersion, dispersion apparatuses or the like known in the art may be properly used. Examples of the dispersion apparatuses may include low speed shearing type dispersion apparatus, high speed shearing type dispersion apparatus, friction type dispersion apparatus, high pressure jet type dispersion apparatus, and ultrasound dispersion apparatus. Among the apparatuses, high speed shearing type dispersion apparatus is preferably used because the particle size of the dispersed particle (oil droplet) can be controlled within 2 μm to 20 μm.

When the high speed shearing type dispersion apparatus is used, conditions such as rotational frequency, dispersion period, and dispersion temperature may be properly selected depending on a purpose. The rotational frequency is preferably 1,000 rpm to 30,000 rpm, and more preferably 5,000 rpm to 20,000 rpm. The dispersion period is preferably 0.1 minutes to 5 minutes in batch processing system. The dispersion temperature is preferably 0° C. to 150° C. under pressure, and more preferably 40° C. to 98° C. Note that dispersion is easily conducted in general in high dispersion temperatures.

A method for forming the base particles of the toner may be properly selected from known methods. Specifically, examples of such methods may include forming the base particles of the toner by a method such as suspension polymerization, emulsion polymerization and aggregation, or dissolution and suspension; and forming the base particles of the toner while adhesive base is formed. Among the examples, preferred method is to form the base particles of the toner while adhesive base is formed. Here the adhesive base is referred to a base adhesive to recording medium such as paper.

In the method of forming the base particles of the toner while adhesive base is formed, toner material contains a compound having an active hydrogen group and a polymer having reactivity to the active hydrogen group, and reaction between the compound having an active hydrogen group and the polymer having reactivity to the active hydrogen group is effected in an aqueous medium to form an adhesive base while the base particles of the toner is formed. Note that the adhesive base may further contain a known binder resin.

Thus obtained toner preferably contains colorant, and may further contain additional components such as a releasing agent, or a charge controlling agent which are properly selected according to the need. The weight average molecular weight of the adhesive base is preferably 3,000 or more, more preferably 5,000 to 1,000,000, and particularly preferably 7,000 to 500,000. The weight average molecular weight of less than 3,000 can result in degraded resistance to hot offset.

A toner used in the present invention is preferably produced by the following production method, but the production method of the toner is not limited to the following method. A production method of a toner used in the present invention at least includes a step of granulation by dissolving or dispersing a binder resin having an aromatic group containing polyester skeleton, a highly polar resin, a colorant, and a releasing agent, and subsequently dispersing the dissolved matter or the dispersed matter in an aqueous medium. The method is specifically described below.

### <Granulation Step>

### (Organic Solvent)

An organic solvent for dissolving or dispersing a binder resin having an aromatic group containing polyester skeleton, a colorant, and a releasing agent preferably has a Hansen solubility parameter of 19.5 or less, which parameter is described in “POLYMER HANDBOOK” 4th Edition, WILEY-INTERSCIENCE, Volume 2, Section VII, a boiling point of less than 100° C. and volatility in view of that subsequent removal of the solvent is conducted easily. Examples of such an organic solvent may include: toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These solvents may be used alone or in combination. Particularly preferred solvents are ester solvents such as methyl acetate, and ethyl acetate; aromatic solvents such as toluene, and xylene; and halogen hydrocarbon such as methylene chloride, 1,2-dichloroethane, chloroform, and carbon tetrachloride. The polyester resin, the colorant, and the releasing agent may be dissolved or dispersed at a time, but typically dissolved or dispersed alone respectively. Organic solvents used for such separate dissolution or dispersion may be the same or different, but preferably the same in view of subsequent treatment of the solvents.

### (Dissolution or Dispersion of Binder Resin Having Aromatic Group Containing Polyester Skeleton)

A solution in which a binder resin having an aromatic group containing polyester skeleton is dissolved or dispersed has a resin concentration of about 40% to 80%. Too high concentration makes dissolution or dispersion difficult, and also makes the handling of the solution hard because of high viscosity. Too low concentration results in only small production amount of a toner. When a binder resin having an aromatic group containing polyester skeleton is mixed with the modified polyester resin having an isocyanate group at its end, the resins may be mixed with the same dissolution or dispersion solution, or dissolution or dispersion solutions may be prepared separately. However, in view of the solubility and the viscosity of each resin, it is preferred to prepare dissolution or dispersion solutions separately.

### (Dissolution or Dispersion of Colorant)

The colorant may be dissolved or dispersed alone, or may be mixed with the dissolution or dispersion solution of the polyester resin. If necessary, a dispersing agent or a polyester resin may further be added, and the masterbatch may be used.

### (Dissolution or Dispersion of Releasing Agent)

When wax is dissolved or dispersed as a releasing agent and an organic solvent is used in which the wax is not dissolved, the solvent is used as a dispersion solution. The dispersion solution is prepared by a general method. That is, the solution may be prepared by mixing an organic solvent and wax and dispersing the wax by using a dispersion apparatus such as a bead mill. Another preparation method can shorten the dispersion period by mixing an organic solvent and wax; subsequently heating the mixture once to the melting point of the wax; cooling the mixture with stirring; and dispersing the wax by using a dispersion apparatus such as a bead mill. The wax may be used in combination of two or more types. A dispersing agent or a polyester resin may further be added.

### (Aqueous Medium)

As for an aqueous medium to be used, water alone may be used, or it is possible to combine water and a solvent miscible with water. The organic solvent having a Hansen solubility parameter of 19.5 or less used in the above oil phase may be mixed with water. The addition of the organic solvent is preferably in an amount of about the saturated amount to water for enhancing emulsification stability or dispersion stability of the oil phase. Examples of solvents usable for mixing with water may include: alcohols such as methanol isopropanol and ethylene glycol; dimethylformamide; tetrahydrofuran; cellosolves such as methylcellosolve; and lower ketones such as acetone, or methyl ethyl ketone. The amount of the aqueous medium to be used based on 100 parts by mass of a toner composition is generally 60 parts by mass to 2,000 parts by mass, and preferably 100 parts by mass to 1,000 parts by mass. When the amount is less than 50 parts by mass, the toner composition is dispersed poorly and toner particles having predetermined sizes cannot be obtained. The amount of more than 2,000 parts by mass is not cost effective.

### (Inorganic Dispersing Agent and Organic Resin Particles)

Before the dissolved or dispersed toner composition is dispersed in the aqueous medium, an inorganic dispersing agent or organic resin particles are preferably dispersed in the aqueous medium in view of enabling sharp particle size distribution and stable dispersion. Examples of the inorganic dispersing agent may include: tricalcium phosphate, calcium carbonate, titanium oxide, colloidal silica, and hydroxyapatite. A resin for forming the organic resin particles may be any resin that can form aqueous dispersion, and the resin may be a thermoplastic resin or a thermosetting resin. Examples of the resin may include: vinyl resins, polyurethane resins, epoxy resins, polyester resins, polyamide resins, polyimide resins, silicon resins, phenolic resins, melamine resins, urea resins, aniline resins, ionomer resins, and polycarbonate resins. These resins may be used in combination. Among the examples, preferred resins are vinyl resins, polyurethane resins, epoxy resins, polyester resins, and combination of the foregoing in view of easily obtaining aqueous dispersion of microspherical resin particles.

### (Method of Dispersing Organic Resin Particles in Aqueous Medium)

The method of processing a resin into an aqueous dispersion solution of organic resin particles is not particularly limited, but examples of the methods (a) to (h) are shown below.

(a) As for vinyl resins, a method of directly producing an aqueous dispersion of resin particles by using monomer as a starting material by polymerization reaction such as suspension polymerization method, emulsion polymerization method, seed polymerization method, or dispersion polymerization method.

(b) As for polyaddition or condensation resins such as polyester resins, polyurethane resins, or epoxy resins, a method of producing an aqueous dispersion of resin particles by dispersing a precursor such as a monomer and an oligomer, or a solvent solution of the precursor in an aqueous medium in the presence of a suitable dispersing agent, and subsequently curing the precursor by heating or adding a curing agent.

(c) As for polyaddition or condensation resins such as polyester resins, polyurethane resins, and epoxy resins, a method of dissolving a suitable emulsifying agent in a precursor such as a monomer and an oligomer, or a solvent solution of the precursor which is preferably liquid or may be turned into liquid by heating, and subsequently adding water thereto to conduct phase inversion and emulsification.

(d) A method of pulverizing a resin by using a pulverizer such as a mechanical rotational type pulverizer or a jet type pulverizer, which resin is prepared in advance by polymerization reaction which may be any polymerization reaction such as addition polymerization, ring opening polymerization, polyaddition, addition condensation, or condensation polymerization; subsequently classifying the pulverized resin to obtain resin particles, and dispersing the particles in water in the presence of a suitable dispersing agent.

(e) A method of spraying a resin solution to obtain resin particles, in which solution a resin is dissolved, which resin is prepared in advance by polymerization reaction which may be any polymerization reaction such as addition polymerization, ring opening polymerization, polyaddition, addition condensation, or condensation polymerization; and subsequently dispersing the particles in water in the presence of a suitable dispersing agent.

(f) A method of precipitating resin particles by adding a solvent to a resin solution obtained by dissolving a resin in a solvent, which resin is prepared in advance by polymerization reaction which may be any polymerization reaction such as addition polymerization, ring opening polymerization, polyaddition, addition condensation, or condensation polymerization; or by cooling a resin solution obtained in advance by dissolving the resin in a solvent under the application of heat; then removing the solvent to obtain resin particles; and subsequently dispersing the particles in water in the presence of a suitable dispersing agent.

(g) A method of dispersing a resin solution in an aqueous medium in the presence of a suitable dispersing agent, which resin solution is obtained by dissolving a resin in a solvent, which resin is prepared in advance by polymerization reaction which may be any polymerization reaction such as addition polymerization, ring opening polymerization, polyaddition, addition condensation, or condensation polymerization; and removing the solvent from thus obtained solution by heating, decompression, or the like.

(h) A method of dissolving a suitable emulsifying agent in a resin solution which is obtained by dissolving a resin in a solvent, which resin is prepared in advance by polymerization reaction which may be any polymerization reaction such as addition polymerization, ring opening polymerization, polyaddition, addition condensation, or condensation polymerization; and subsequently adding water thereto to conduct phase inversion and emulsification.

### (Surfactant)

To emulsify or disperse an oil phase containing a toner composition in an aqueous medium, a surfactant or the like may be used if necessary. Examples of the surfactant may include: anionic surfactants such as alkylbenzene sulfonic acid salts, α-olefin sulfonic acid salts, and phosphoric esters; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, and polyhydric alcohol derivatives; and ampholytic surfactants such as alanine, dodecyldi(aminoethyl)glycine, di(octylaminoethyl)glycine, and N-alkyl-N,N-dimethylammonium betaine.

By using a surfactant having a fluoroalkyl group, expected effect can be obtained with just a small amount of the surfactant. Specific examples of preferably used anionic surfactants having a fluoroalkyl group may include C₂₋₁₀ fluoroalkyl carboxylic acids and their metal salts, disodium perfluorooctanesulfonylglutamate, sodium 3-[ω-fluoroalkyl(having 6 to 11 carbon atoms)oxy]-1-alkyl(having 3 to 4 carbon atoms)sulfonate, sodium 3-[ω-fluoroalkanoyl (having 6 to 8 carbon atoms)-N-ethylamino]-1-propanesulfonate, fluoroalkyl(having 11 to 20 carbon atoms) carboxylic acids and their metal salts, perfluoroalkylcarboxylic acids (having 7 to 13 carbon atoms) and their metal salts, perfluoroalkyl (having 4 to 12 carbon atoms)sulfonate and their metal salts, perfluorooctanesulfonic acid diethanol amides, N-propyl-N-(2-hydroxyethyl)perfluorooctanesulfone amide, perfluoroalkyl (having 6 to 10 carbon atoms)sulfoneamidepropyltrimethylmmonium salts, salts of perfluoroalkyl(having 6 to 10 carbon atoms)-N-ethylsulfonyl glycine, and monoperfluoroalkyl (having 6 to 16 carbon atoms)ethylphosphates. Specific examples of cationic surfactants may include primary, secondary and secondary aliphatic amines having a fluoroalkyl group, aliphatic quaternary ammonium salts such as perfluoroalkyl (having 6 to 10 carbon atoms)sulfoneamidepropyltrimethylammonium salts, benzalkonium salts, benzethonium chloride, pyridinium salts, and imidazolinium salts.

### (Protection Colloid)

It is also possible to stabilize dispersed droplets by using a polymeric protection colloid. Specific examples of such protection colloids may include homopolymers and copolymers prepared by using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), (meth)acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, glycerinmonomethacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (e.g, vinyl acetate, vinyl propionate and vinyl butyrate); acrylamide, methacrylamide and diacetoneacrylamide and their methylol compounds; acid chlorides (e.g., acrylic acid chloride and methacrylic acid chloride); and monomers having a nitrogen atom or an heterocyclic ring having a nitrogen atom (e.g., vinyl pyridine, vinyl pyrrolidone, vinyl imidazole and ethylene imine); polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose. When compounds such as calcium phosphate salt which are soluble in an acid or alkali are used as a dispersion stabilizer, calcium phosphate salt is dissolved by adding an acid such as hydrochloric acid and washing the resultant particles with water to remove calcium phosphate salt therefrom. Alternatively, such a dispersion stabilizer can also be removed by using a decomposition process using an enzyme. When a dispersing agent is used, the dispersing agent may be remained on the surfaces of toner particles, but the particles are preferably washed to remove the dispersing agent in view of the charging properties of toner.

### (Dispersion Method)

The dispersion method is not particularly limited, and known equipment may be used such as low speed shearing type, high speed shearing type, friction type, high pressure jet type, and ultrasonic type. Among these types, high speed shearing type is preferably used for preparing dispersed particles having a particle size of from 2 μm to 20 μm. When a high speed shearing type dispersion apparatus is used, its rotational frequency is not particularly limited, but the rotational frequency is typically from 1,000 rpm to 30,000 rpm, and preferably from 5,000 rpm to 20,000 rpm. The temperature in the dispersion process is typically from 0° C. to 150° C. (under pressure), and preferably from 20° C. to 80° C.

### (Desolvation)

In order to remove an organic solvent from thus obtained emulsified dispersion, known methods may be used such as a method where the temperature of the whole system is gradually increased under normal pressure or reduced pressure to evaporate and completely remove the organic solvent from droplets.

<Elongation and/or Crosslinking Reaction>

When a modified polyester resin having an isocyanate group at its end and amines having reactivity to the resin are added for the purpose of incorporating a modified polyester resin having urethane or/and urea group, the amines may be mixed with a toner composition in an oil phase before the toner composition is dispersed in an aqueous medium, or the amines may be added to the aqueous medium. The period required for the reaction is selected depending on the isocyanate group structure of the polyester prepolymer and the reactivity of the amines, and is typically from 1 minute to 40 hours and preferably from 1 hour to 24 hours. The reaction temperature is typically from 0° C. to 150° C. and preferably from 20° C. to 98° C. The reaction may be conducted prior to the step of adhering particles, simultaneously during the step of adhering particles, or after the step of adhering particles. Known catalysts may also be used if necessary.

### <Washing and Drying Step>

In the step of washing and drying toner particles dispersed in an aqueous medium, known techniques are used. That is, impurities and surfactant are removed by repeating several times a step of subjecting the toner particles to solid-liquid separation by using a centrifuge, a filter press, or the like; subsequently redispersing thus obtained toner cake in ion exchanged water in normal temperature to about 40° C.; adjusting the pH of thus obtained solution by using an acid or alkali if necessary; and subjecting the solution to solid-liquid separation again. After that, thus obtained solid is dried by using an apparatus such as a pneumatic conveying dryer, an air-circulation dryer, a reduced-pressure dryer, or a vibrating fluidization dryer. In this case, particle components of the toner may be removed by centrifugal separation. If necessary, after the drying, the powder may be classified to obtain a toner with a desired particle size distribution by using a known classifier.

### <External Additive Treatment>

The obtained toner powder after drying may be mixed with different particles such as the charge controlling particles, or flowability enhancer particles, and mechanical impact may be given to the mixed powder so that the particles are fixed or fused on the surface to each other, which prevents separation of the different particles from the surface of the obtained complex particles. Specifically, mechanical impact may be given to the mixture by using high speed rotating blades; by introducing the mixture into a high-speed gas flow to be accelerated so that the particles collide with each other or the complex particles are made to strike a suitable impact plate; or the like. Examples of an apparatus used for this purpose may include: a HENSCHEL MIXER (manufactured by MITSUI MINING COMPANY, LIMITED), a SUPERMIXER (manufactured by KAWATA MFG Co., Ltd.), an ANGMILL (manufactured by Hosokawa Micron Corporation), an I-MILL (manufactured by Japan Pneumatic) that is modified to reduce the air pressure upon pulverizing, a Hybridization system (manufactured by Nara Machine Laboratories), a Kryptron system (manufactured by Kawasaki Heavy Industries), and an automatic mortar.

### EXAMPLES

The present invention will be described in more detail referring to examples and comparative examples hereinafter. It should be understood that the examples do not limit the present invention. In the following description, every “part(s)” means part(s) by mass.

### <Synthesis of Polyester>

### (Polyester 1)

In a reaction vessel equipped with a condenser tube, stirrer, and nitrogen inlet tube, 553 parts of bisphenol A ethylene oxide dimolar adduct, 196 parts of bisphenol A propylene oxide dimolar adduct, 220 parts of terephthalic acid, 45 parts of adipic acid and 2 parts of dibutyl tin oxide were placed, and the reaction was performed under normal pressure at 230° C. for 8 hours, and under a reduced pressure of 10 mmHg to 15 mmHg for 5 hours, then 46 parts of anhydrous trimellitic acid was introduced into the reaction vessel, and the reaction performed at 180° C. under normal pressure for 2 hours to obtain [polyester 1]. The [polyester 1] had a number average molecular weight of 2,200, weight average molecular weight of 5,600, Tg of 43° C. and acid value of 13.

### <Synthesis of Prepolymer>

In a reaction vessel equipped with a condenser tube, stirrer, and nitrogen inlet tube, 682 parts of bisphenol A ethylene oxide dimolar adduct, 81 parts of bisphenol A propylene oxide dimolar adduct, 283 parts of terephthalic acid, 22 parts of anhydrous trimellitic acid and 2 parts of dibutyl tin oxide were placed, and the reaction was performed under normal pressure at 230° C. for 8 hours, and then under a reduced pressure of 10 mmHg to 15 mmHg for 5 hours to obtain [intermediate polyester 1]. The [intermediate polyester 1] had a number average molecular weight of 2,100, weight average molecular weight of 9,500, Tg of 55° C., acid value of 0.5 and hydroxyl value of 49.

Next, 411 parts of [intermediate polyester 1], 89 parts of isophorone diisocyanate and 500 parts of ethyl acetate were placed in a reaction vessel equipped with a condenser tube, stirrer, and nitrogen inlet tube, and the reaction was performed at 100° C. for 5 hours to obtain [prepolymer 1]. The free isocyanate percent by weight of [prepolymer 1] was 1.53%.

### <Synthesis of Masterbatch>

By using a HENSCHEL MIXER, 40 parts of carbon black (REGAL 400R manufactured by Cabot Corporation), 60 parts of binder resin/polyester resin (RS-801, acid value: 10, Mw: 20,000, Tg: 64° C., manufactured by Sanyo Chemical Industries, Ltd.), and 30 parts of water were mixed to obtain a mixture where pigment aggregates were impregnated with water. The mixture was kneaded by using two rollers the surfaces of which were set at 130° C. for 45 minutes, and pulverized with a pulverizer into the size of +1 mm to obtain [masterbatch 1].

### Example 1

### Preparation of Pigment/Wax Dispersion (Oil Phase)>

To a vessel equipped with a stirrer bar and a thermometer, 378 parts of [polyester 1], 120 parts of paraffin wax (HNP9), 96 parts (releasing agent ratio: 80%) of a releasing agent (WAX) dispersing agent (styrene-polyethylene polymer, Tg: 73° C., number average molecular weight: 7,100), and 1,450 parts of ethyl acetate were placed, and the temperature was raised to 80° C. with stirring, maintained at 80° C. for 5 hours, and cooled to 30° C. in 1 hour. Next, 500 parts of [masterbatch 1], and 500 parts of ethyl acetate were placed into the vessel and mixed for 1 hour to obtain [initial material solution 1].

To a vessel 1,500 parts of the [initial material solution 1] was transferred, and carbon black and WAX were dispersed using a bead mill (Ultra Visco Mill manufactured by AIMEX CO., LTD.) under the conditions of liquid feed rate 1 kg/hr, disk circumferential speed of 6 m/sec, 0.5 mm zirconia beads filled to 80% by volume and three passes (three times). Next, 655 parts of 65% of ethyl acetate solution of [polyester 1] was added to the dispersed solution and then dispersed once (1 pass) by using the bead mill under the same conditions as described above to obtain [pigment/WAX dispersion 1]. The [pigment/WAX dispersion 1] was adjusted by using ethyl acetate so that the solution has 50% concentration of solid content (130° C., 30 minutes).

### <Preparation of Aqueous Phase>

By mixing and stirring 953 parts of ion exchanged water, 88 parts of 25 wt % aqueous dispersion of organic resin particles for stable dispersion (copolymer of styrene-methacrylic acid-butyl acrylate-sodium salt of methacrylic acid ethylene oxide adduct sulfate), 90 parts of a 48.5% aqueous solution of sodium dodecyl diphenylether disulfonic acid (ELEMINOL MON-7 manufactured by Sanyo Chemical Industries, Ltd.) and 113 parts of ethyl acetate, a translucent white solution was obtained. The solution is defined as [aqueous phase 1].

### <Emulsification Step>

By using a TK homomixer (manufactured by Tokushu Kika Kogyo Co., Ltd.), 967 parts of [pigment/WAX dispersion 1], 2% (relative to solid content of toner) of Claytone APA (quaternary alkyl ammonium ion modified layered inorganic compound, manufactured by Southern Clay Products, Inc.) as layered inorganic mineral, and 6 parts of isophoronediamine as amines were mixed at 5,000 rpm for 1 minute. Then 137 parts of [prepolymer 1] was added thereto and mixed at 5,000 rpm for 1 minute by using the TK homomixer (manufactured by Tokushu Kika Kogyo Co., Ltd.). After that, 1200 parts of [aqueous phase 1] was added thereto and mixed by using the TK homomixer with adjusting its rotational frequency 8,000 rpm to 13,000 rpm for 20 minutes to obtain [emulsion slurry 1].

### <Desolvation>

[Emulsion slurry 1] was placed in a vessel equipped with a stirrer and a thermometer, then the solvent was removed at 30° C. for 8 hours to obtain [dispersion slurry 1].

### <Washing and Drying>

After filtering 100 parts of [dispersion slurry 1] under reduced pressure,

(1): 100 parts of ion exchanged water were added to the filter cake, mixed by using the TK homomixer (rotational frequency: 12,000 rpm, 10 minutes) and subsequently filtered.
(2): 900 parts of ion exchanged water were added to the filter cake of (1), mixed by using the TK homomixer (rotational frequency: 12,000 rpm, 30 minutes) with adding supersonic vibration and subsequently filtered under reduced pressure. These procedures were repeated until the reslurry solution had a conductivity of 10 μC/cm or less.
(3): 10% hydrochloric acid was added to the reslurry solution so that the solution has a pH of 4, and the solution was stirred by using a three-one motor for 30 minutes and subsequently filtered.
(4): 100 parts of ion exchange water were added to the filter cake of (3), mixed by using the TK homomixer (rotational frequency: 12,000 rpm, 10 minutes), and subsequently filtered. These procedures were repeated until the reslurry solution had a conductivity of 10 μC/cm or less to obtain [filter cake 1].
[Filter cake 1] was dried by using an air-circulation dryer at 45° C. for 48 hours, and sieved through a sieve of 75 μm mesh to obtain [toner base 1]. The [toner base 1] had a volume average particle size (Dv) of 5.8 μm, a number average particle size (Dp) of 5.2 μm, a Dv/Dp of 1.12, an average circularity of 0.973, and an ATR value of 0.04. Then 100 parts of the base toner and 1.5 parts of hydrophobic silica H2000/4 (particle size of 12 nm, manufactured by Clariant), and 0.5 parts of hydrophobic silica RX50 (particle size of 40 nm, manufactured by NIPPON AEROSIL CO., LTD.) were mixed by using a HENSCHEL MIXER to obtain [developer 1] according to the present invention.

### Examples 2 to 6

As shown in the evaluation results of toners in Tables 1-A and 1-B, the same processes as Example 1 were conducted except that conditions in Example 1 were changed in terms of the weight ratio (%) of the releasing agent dispersing agent based on the solid content of the releasing agent, the amount of the modified laminar inorganic mineral, and the amount of the external additive to obtain the developers of Examples 2 to 6.

### Comparative Examples 1 to 3

As shown in the evaluation results of toners in Tables 1-A and 1-B, the same processes as Example 1 were conducted except that conditions in Example 1 were changed in terms of the weight ratio (%) of the releasing agent dispersing agent based on the solid content of the releasing agent, and the amount of the modified laminar inorganic mineral to obtain the developers of Comparative Examples 1 to 3.

The toners obtained in Examples 1 to 6 and Comparative Examples 1 to 3 were analyzed and evaluated as described below. The toners were evaluated below as single component developers. However, toners of the present invention may also be used as two component developers by conducting suitable external additive treatment and using a suitable carrier.

### <Measurement Method>

### (Particle Size)

Next, there is described a method of measuring the particle size distribution of toner particles. Examples of a measurement apparatus for the particle size distribution of toner particles by Coulter Counter method may include Coulter Counter TA-II and Coulter Multisizer II (both manufactured by Coulter Electronics, Inc.). Measurement method is described below.

First, 0.1 ml to 5 ml of a surfactant, preferably a salt of alkylbenzenesulfonic acid, is added as a dispersing agent to 100 ml to 150 ml of an electrolytic solution. The electrolytic solution is an about 1% aqueous solution of NaCl prepared by using first-grade sodium chloride. For example, ISOTON-II manufactured by Coulter Electronics, Inc. may be used for the preparation. To the solution, 2 mg to 20 mg (relative to solid content) of a measurement sample is added. The electrolytic solution in which the sample has been suspended is subjected to a dispersing treatment for about 1 minute to 3 minutes by using an ultrasonic dispersing apparatus. By using the measurement apparatus with 100 μm aperture, the volume and the number of the toner particles or toner are measured, and volume distribution and number distribution are calculated. Based on thus obtained distributions, the volume average particle size (Dv) and the number average particle size (Dp) of the toner can be obtained.

As for channels, there were used 13 channels such as 2.00 μm to less than 2.52 μm; 2.52 μm to less than 3.17 μm; 3.17 μm to less than 4.00 μm; 4.00 μm to less than 5.04 μm; 5.04 μm to less than 6.35 μm; 6.35 μm to less than 8.00 μm; 8.00 μm to less than 10.08 μm; 10.08 μm to less than 12.70 μm; 12.70 μm to less than 16.00 μm; 16.00 μm to less than 20.20 μm; 20.20 μm to less than 25.40 μm; 25.40 μm to less than 32.00 μm; and 32.00 μm to less than 40.30 μm to measure particles having a size of 2.00 μm or more and less than 40.30 μm.

### (Average Circularity)

To measure the shape of toner particles, it is suitable to use the optical detection method in which a suspension containing the particles is passed through an image detection unit on a plate, and a CCD camera is used to optically capture an image of particles to analyze the particles. By using the method, a projected area of a toner particle can be measured. The average circularity is calculated by dividing the perimeter of a circle having the same projected area as the actual toner particle with the perimeter of the toner particle.

The value is measured as average circularity by using a flow particle image analyzer FPIA-2000. Specifically describing the measurement process, first, to a container filled with from 100 ml to 150 ml of water from which solid impurities has been removed beforehand, a surfactant, preferably from 0.1 ml to 0.5 ml of alkylbenzenesulfonate salt, is added as a dispersing agent, and about 0.1 g to 0.5 g of a measurement sample is further added. By using a supersonic dispersing apparatus, the suspension in which the sample is dispersed is subjected to dispersing treatment for about 1 minute to 3 minutes to make the particle concentration of the dispersion to be from 3,000 particles/μl to 10,000 particles/μl. Then the above analyzer is used to measure the shape and the distribution of the toner to obtain the average circularity.

### (Molecular Weight)

The molecular weights of used polyester resins and vinyl copolymer resins were measured by normal GPC (gel permeation chromatography) under the following conditions. Apparatus: HLC-8220GPC manufactured by Tosoh Corporation Column: TSKgel SuperHZM-M×3 Temperature: 40° C. Solvent: THF (tetrahydrofuran) Flow rate: 0.35 ml/minute Sample: injecting 0.01 ml of 0.05% to 0.6% concentration sample The weight average molecular weight Mw was calculated based on the molecular weight distribution of the toner resin determined under the conditions by using a calibration curve prepared by using monodisperse polystyrene standard samples. As for the monodisperse polystyrene standard samples, 10 samples in the range of from 5.8×100 to 7.5×1,000,000 were used.

### (Glass Transition Point)

The glass transition point of used polyester resins and vinyl copolymer resins can be measured, for example, by using a differential scanning calorimetry such as DSC-6220R manufactured by Seiko Instruments Inc. First, a sample is heated from room temperature to 150° C. at a temperature increase rate of 10° C./min. Then the sample is left at 150° C. for 10 minutes, cooled to room temperature and left for 10 minutes, and heated again to 150° C. at a temperature increase rate of 10° C./min. The glass transition point can be determined by the point of intersection of a base line at glass transition point or less and the tangent line of a curve representing glass transition.

### (Particle Size)

The particle sizes of used vinyl copolymer resin particles can be determined in the state of dispersion, for example, by using a measurement apparatus such as LA-920 manufactured by HORIBA, Ltd. or UPA-EX150 manufactured by NIKKISO CO., LTD.

### (Amount of Surface Releasing Agent)

A method of determining the amount of surface releasing agent is described below. The amount was determined by ATR method (Ge crystal was used) with a FT-IR manufactured by PerkinElmer, Inc. by measuring the surface of a disc-shaped toner prepared by pressing toner under the application of 6 tons for 1 minute. The amount of surface releasing agent was defined as relative intensity ratio of peak intensity at 2,850 cm⁻¹ (Wax component) to peak intensity at 828 cm⁻¹ (resin component) in absorbance.

### (Calculation of Surface Coverage)

A method of calculating the coverage of the surface of toner by an external additive is described below. The projected area of the toner was calculated. Based on the projected area of the external additive, projected area of the toner according to the additional amount of the external additive was calculated. The coverage was calculated from the ratio of the projected area of the external additive to the projected area of the toner. The particle sizes of the toner were determined by Coulter Counter method. The particle sizes of the external additive were determined by using SEM. In both of the cases, the particle sizes of 1,000 particles were determined and average sizes were calculated. Specific gravity was determined by pycnometer method.

### (Volume Specific Resistance)

The volume specific resistance was determined by using LORESTA GP manufactured by DIA Instruments Co., Ltd. in compliance with JIS-K7194.

### <Evaluation Method>

### (Cleaner-Less Aptitude Test: Developer Collecting Property)

A system without a cleaner for a latent electrostatic image bearing member having the same configuration as the embodiment shown in FIG. 2 was prepared by replacing the charging roller of IPSIO CX3000 manufactured by Ricoh Company, Ltd. with a brush roller, replacing a cleaning blade for a latent electrostatic image bearing member with a conductive sheet so that the sheet was in contact with the surface of the latent electrostatic image bearing member. One thousand sheets of a predetermined print pattern with a B/W ratio of 6% were printed continuously 1,000 times in monochrome mode under N/N conditions (23° C., 45%). At this time, cleaner-less aptitude was evaluated by ranking developer collecting properties.

(I) The developer collecting property was evaluated by stripping toner remaining on the photoconductor by using a tape after the 1,000 print sheets were printed, and measuring L* with a spectral densitometer X-RITE 939. A: 90 or more B: 85 or more to less than 90 C: 80 or more to less than 85 D: less than 80

(II) The presence of adhering matter on the conductive sheet (charging member) was visually checked and evaluated by sensory inspection for a black vertical streak and band on printed images caused by charging failure according to the following standards. A: no streaks and bands were observed in a dot image (2×2) at 600 dpi B: small streaks and a few of faint bands (10 or less) were observed in a dot image (2×2) at 600 dpi D: many and large streaks and bands were observed in a dot image (2×2) at 600 dpi

By using the measurement methods mentioned above, the contact angle with pure water and the Shore D hardness of conductive sheets that were used in evaluation of Examples and Comparative Examples were measured.

In Tables 1-A and 1-B, there are described the measurement results, the weight ratio (%) of the releasing agent dispersing agent based on the solid content of the releasing agent, the used amount of the modified laminar inorganic mineral, and the used amount of the external additive of the toners (developer) of obtained in Examples and Comparative Examples. There are also described the material of the recharging member, contact angle, hardness (Shore D), the thickness of the sheet, volume specific resistance, applied voltage, and contact nip in the image formation apparatus used for the measurements.

TABLE 1-A

| | Toner composition | | | | | |
|---|---|---|---|---|---|---|
| | | Amount | | | | |
| | | ratio | | | | |
| | | of releasing | | | | |
| | Laminar | agent | | | | |
| | inorganic | dispersing | | | | |
| | mineral | agent | | | | |
| | Amount | (Relative to | | | | |
| | (wt %)(Relative to | releasing | | | | |
| | toner solid | agent solid | | External treatment | | |
| | content) | content) | ATR value | H2000/4 | RX50 | Coverage % |
| Ex. 1 | 2 | 80 | 0.04 | 1.5 | 0.5 | 100 |
| Ex. 2 | 2 | 80 | 0.04 | 2 | 1 | 139 |
| Ex. 3 | 2 | 50 | 0.09 | 1.5 | 0.5 | 100 |
| Ex. 4 | 2 | 80 | 0.04 | 1.5 | 0.5 | 100 |
| Ex. 5 | 2 | 80 | 0.04 | 1.5 | 0.5 | 100 |
| Ex. 6 | 0.05 | 80 | 0.06 | 1.5 | 0.5 | 100 |
| Compara. | Not | 50 | 0.09 | 1.5 | 0.5 | 100 |
| Ex. 1 | added | | | | | |
| Compara. | 2 | 20 | 0.12 | 1.5 | 0.5 | 100 |
| Ex. 2 | | | | | | |
| Compara. | 2 | 80 | 0.04 | 1.5 | 0.5 | 100 |
| Ex. 3 | | | | | | |

TABLE 1-B

| | Charging member for recharging remaining toner | | | | | | | Evaluation result | | |
|---|---|---|---|---|---|---|---|---|---|---|
| | on latent electrostatic image bearing member | | | | | | | | Collecting property | |
| | | | | Sheet | | Applied | Contact | Adhesion of | of developer | |
| | | Contact | Hardness | thickness | Resistance* | voltage | nip width | conductive | | Evaluation |
| | Material | angle | (Shore D) | (mm) | (W) | (V) | (mm) | sheet | L* | rank |
| Ex. 1 | FEP sheet | 115 | 65 | 0.1 | 10E+5 | −200 | 3 | A | 92 | A |
| Ex. 2 | FEP sheet | 115 | 65 | 0.5 | 10E+5 | −200 | 3 | B | 93 | A |
| Ex. 3 | FEP sheet | 115 | 65 | 0.1 | 10E+5 | −200 | 3 | B | 91 | A |
| Ex. 4 | PTFE | 114 | 50 | 0.1 | 10E+5 | −200 | 3 | A | 90 | A |
| | sheet | | | | | | | | | |
| Ex. 5 | PFA sheet | 108 | 64 | 0.1 | 10E+5 | −200 | 3 | B | 90 | A |
| Ex. 6 | FEP sheet | 115 | 65 | 0.1 | 10E+5 | −200 | 3 | B | 86 | B |
| Compara. | FEP sheet | 115 | 65 | 0.1 | 10E+5 | −200 | 3 | B | 72 | D |
| Ex. 1 | | | | | | | | | | |
| Compara. | FEP sheet | 115 | 65 | 0.1 | 10E+5 | −200 | 3 | D | 76 | D |
| Ex. 2 | | | | | | | | | | |
| Compara. | PVDF | 108 | 80 | 0.1 | 10E+5 | −200 | 3 | D | 70 | D |
| Ex. 3 | sheet | | | | | | | | | |

*resistance represents volume specific resistance.

As shown in the measurement results, use of an image forming method and a process cartridge according to the present invention enables reusing toner remaining on a latent electrostatic image bearing member without collecting and discarding the toner, thereby reducing environmental burden; preventing contamination of a charging member for the latent electrostatic image bearing member and a recharging member; easily collecting the remaining toner in a developing step; excellent image stability; and less deterioration in durability.

What is claimed is:

1. An image forming method comprising:
forming a latent electrostatic image on a latent electrostatic image bearing member for bearing the latent electrostatic image;
developing the latent electrostatic image to form a visible toner image by using a toner; and
recharging untransferred toner remaining on the latent electrostatic image bearing member by using a recharging member to remove the remaining toner from the latent electrostatic image bearing member;
wherein the recharging member is a conductive member a surface of which has a contact angle of 108° or more with pure water and a Shore D hardness of 50 to 65;
the toner is formed by making an external additive adhere to a toner base granulated by dispersing and/or emulsifying in an aqueous medium an oil phase containing a toner composition that contains at least a pigment, a releasing agent, and a modified laminar inorganic mineral obtained by modifying at least part of interlayer ions by using organic ions and/or a precursor of the toner composition;
the coverage of the surface of the toner by the external additive is 150% or less, which coverage is calculated from the average particle size of the toner base and the external additive;
and a ratio between a peak of 2,850 cm⁻¹ from the releasing agent and a peak of 828 cm⁻¹ from a binder resin is 0.02 to 0.1, which peaks are obtained by ATR method.

2. The image forming method according to claim 1, wherein the conductive member has a surface resistivity of 10² Ω/sq to 10⁸ Ω/sq.

3. The image forming method according to claim 1, wherein the conductive member has a volume resistivity of 10² Ω·cm to 10⁶ Ω·cm.

4. The image forming method according to claim 1, wherein the conductive member is a conductive sheet composed of any one selected from nylon, PTFE, PVDF, and urethane.

5. The image forming method according to claim 4, wherein the conductive sheet has a thickness of 0.05 mm to 0.5 mm.

6. The image forming method according to claim 4, wherein a voltage of −1.4 kV to 0 kV is applied to the conductive sheet.

7. The image forming method according to claim 4, wherein the conductive sheet is in contact with the latent electrostatic image bearing member with a nip width of 1 mm to 10 mm.

8. The image forming method according to claim 1, wherein the modified laminar inorganic mineral is obtained by modifying at least part of interlayer cations contained in layered inorganic mineral by using organic cations.

9. The image forming method according to claim 1, wherein 0.05 weight percent to 2 weight percent of the modified laminar inorganic mineral is contained based on the solid content of the toner in the oil phase.

10. A process cartridge comprising:
a latent electrostatic image bearing member configured to bear a latent electrostatic image;
a developing unit configured to develop the latent electrostatic image to form a visible image by using a toner; and
a recharging unit configured to recharge untransferred toner remaining on the latent electrostatic image bearing member;
wherein the recharging member is a conductive member a surface of which has a contact angle of 108° or more with pure water and a Shore D hardness of 50 to 65;
the toner is formed by making an external additive adhere to a toner base granulated by dispersing and/or emulsifying in an aqueous medium an oil phase containing a toner composition that contains at least a pigment, a releasing agent, and a modified laminar inorganic mineral obtained by modifying at least part of interlayer ions by using organic ions and/or a precursor of the toner composition;
the coverage of the surface of the toner by the external additive is 150% or less, which coverage is calculated from the average particle size of the toner base and the external additive;
and a ratio between a peak of 2,850 cm⁻¹ from the releasing agent and a peak of 828 cm⁻¹ from a binder resin is 0.02 to 0.1, which peaks are obtained by ATR method.

11. The process cartridge according to claim 10, wherein the conductive member has a surface resistivity of 10² Ω/sq to 10⁸ Ω/sq.

12. The process cartridge according to claim 10, wherein the conductive member has a volume resistivity of 10² Ω·cm to 10⁶ Ω·cm.

13. The process cartridge according to claim 10, wherein the conductive member is a conductive sheet composed of any one selected from nylon, PTFE, PVDF, and urethane.

14. The process cartridge according to claim 13, wherein the conductive sheet has a thickness of 0.05 mm to 0.5 mm.

15. The process cartridge according to claim 13, wherein a voltage of −1.4 kV to 0 kV is applied to the conductive sheet.

16. The process cartridge according to claim 13, wherein the conductive sheet is in contact with the latent electrostatic image bearing member with a nip width of 1 mm to 10 mm.

17. The process cartridge according to claim 10, wherein the modified laminar inorganic mineral is obtained by modifying at least part of interlayer cations contained in layered inorganic mineral by using organic cations.

18. The process cartridge according to claim 10, wherein 0.05 weight percent to 2 weight percent of the modified laminar inorganic mineral is contained based on the solid content of the toner in the oil phase.

19. An image forming apparatus comprising:
a latent electrostatic image bearing member;
a developing unit configured to develop a latent electrostatic image on the latent electrostatic image bearing member to form a visible toner image by using a toner; and
a recharging member configured to recharge untransferred toner remaining on the latent electrostatic image bearing member;
wherein the recharging member is a conductive member a surface of which has a contact angle of 108° or more with pure water and a Shore D hardness of 50 to 65;
the toner is formed by making an external additive adhere to a toner base granulated by dispersing and/or emulsifying in an aqueous medium an oil phase containing a toner composition that contains at least a pigment, a releasing agent, and a modified laminar inorganic mineral obtained by modifying at least part of interlayer ions by using organic ions and/or a precursor of the toner composition;
the coverage of the surface of the toner by the external additive is 150% or less, which coverage is calculated from the average particle size of the toner base and the external additive;
and a ratio between a peak of 2,850 cm⁻¹ from the releasing agent and a peak of 828 cm⁻¹ from a binder resin is 0.02 to 0.1, which peaks are obtained by ATR method.
